(19) United States
(12) Patent Application Publication
(10) Pub. No.: US 2011/0183859 A1
(43) Pub. Date: Jul. 28, 2011

(54) INFLAMMATORY GENES AND MICRORNA-21 AS BIOMARKERS FOR COLON CANCER PROGNOSIS

(75) Inventors: Curtis C. Harris, Garrett Park, MD (US); Aaron J. Schetter, Rockville, MD (US)

(73) Assignees: THE UNITED STATES OF AMERICA, AS REPRESENTED BY THE SECRETARY,; DEPARTMENT OF HEALTH AND HUMAN SERVICES

(21) Appl. No.: 13/121,020

(22) PCT Filed: Sep. 25, 2009
(86) PCT No.: PCT/US09/58425

§ 371 Date: Mar. 25, 2011

Related U.S. Application Data
(60) Provisional application No. 61/194,340, filed on Sep. 25, 2008.

(51) Int. Cl. C40B 30/00; C40B 40/06

(52) U.S. Cl. 506/7; 506/16

(57) ABSTRACT

Disclosed herein are methods for detecting a more aggressive form of a colon adenocarcinoma in a subject, thereby predicting the prognosis of the subject. The methods generally include determining an inflammatory gene expression signature in the colon adenocarcinoma and/or the adjacent non-cancerous tissue. In some embodiments, the inflammatory genes include, but are not limited to, PRG1, ANXA1, IL-17a, IL-23a FOXP3, HLA-DRA, IL-10, CD68 and IL-12a. In some embodiments, the method further includes detecting expression of microRNA-21 (miR-21) in the colon adenocarcinoma. Altered expression of one or more of the inflammatory genes or miR-21 indicates the prognosis of the subject. Also provided are arrays consisting essentially of probes specific for PRG1, ANXA1, IL-17a, IL-23a, FOXP3, HLA-DRA, IL-10, CD68, IL-12a and miR-21.

### CROSS-REFERENCE TO RELATED APPLICATION

This application claims priority to U.S. Provisional Application No. 61/194,340 filed Sep. 25, 2008, herein incorporated by reference in its entirety.

### FIELD

This disclosure concerns biomarkers that can be used for detecting an aggressive tumor, predicting the prognosis of a patient with colon cancer, and selecting an appropriate anti-tumor therapy.

### BACKGROUND

Colon adenocarcinoma is a leading cause of cancer mortality worldwide (Aaltonen and Hamilton, World Health Organization, International Agency for Research on Cancer, 2000). Current adjuvant treatment modalities improve survival for TNM (tumor-node metastasis) stage III colon cancer patients, but it remains controversial if stage II patients should be given these therapies (Chua et al., Expert Rev Anticancer Ther 8:595-604, 2008; Wolpin & Mayer, Gastroenterology 134:1296-310, 2008). Some stage II patients will benefit from therapy; but therapy for others will harm quality of life with little therapeutic benefit. Therefore, it is important to develop biomarkers to identify high risk, stage II patients that may be suitable for therapeutic intervention.

Inflammation plays a key role in tumor initiation, progression and metastasis (Hussain and Harris, Int J Cancer 121:2373-80 2007; DeNardo et al., Cancer Metastasis Rev 27:11-8 2008; Fantini & Pallone, Curr Drug Targets 9:375-80, 2008). Chronic inflammation is associated with increased rates of colon cancer for both ulcerative colitis and Crohn's disease (Ekbom et al., Lancet 336:357-9, 1990; Ekbom et al., N Engl J Med 323:1228-33, 1990; Bernstein et al., Cancer 91:854-62, 2001). Nonsteroidal anti-inflammatory drugs can reduce colon cancer risk (Cha & DuBois, Annu Rev Med 58:239-52, 2007). Inflammation-modulating cytokines affect tumor development through roles in cell proliferation, angiogenesis and apoptosis (Lin & Karin, J Clin Invest 117:1175-83, 2007). Cytokines can signal changes directly within the tumor or the tumor microenvironment to influence cancer progression (Mantovani et al., Lancet 371:771-83, 2008). Since inflammation contributes to colon carcinogenesis, expression of inflammatory genes may serve as biomarkers for colon cancer. Infiltration of inflammatory cells in colorectal cancer has been associated with prognosis (Jass et al., Lancet 1:1303-6, 1987; Galon et al., Science 313:1960-4, 2006; Pages et al., N Engl J Med 353:2654-66, 2005). Furthermore, polymorphisms in inflammatory genes have been associated with colon cancer incidence and prognosis (Landi et al., Eur J Cancer 43:762-8, 2007; Lurje et al., Ann Oncol 2008; Wilkening et al., Carcinogenesis 29:1202-6, 2008). Expression of inflammatory genes has also been associated with TNM staging and prognosis in colon cancer (Pages et al., Int J Cancer 84:326-30, 1999; Berghella et al., Cancer Biother Radiopharm 21:468-87, 2006).

Previous studies have identified unique expression signatures composed of inflammatory/immune-response genes that predict metastatic progression and survival of hepatocellular carcinoma (Budhu et al., Cancer Cell 10:99-111, 2006) and lung adenocarcinoma (Seike et al., J Natl Cancer Inst 99:1257-69, 2007; PCT Publication No. WO 2008/009028) patients. However, a need remains to identify useful biomarkers for other types of cancer, including colon adenocarcinoma. Thus, disclosed herein the identification of an inflammatory gene signature that can be used to predict the prognosis of a patient with colon adenocarcinoma.

### SUMMARY

There is a need to identify biomarkers useful for predicting prognosis of patients with colon adenocarcinoma. The ability to classify patients as high risk (poor prognosis) or low risk (favorable prognosis) would enable selection of appropriate therapies for these patients. For example, high risk patients are likely to benefit from aggressive therapy, whereas therapy may have no significant advantage for low risk patients. However, in spite of this need, a solution to this problem has not been available.

It is shown herein that there are systematic changes in inflammatory gene expression in colon tumors. Expression of IL-8, IL-23a, IL-1a, IL-1b, FOXP3 IL-17a, IFN-γ and IL-6 were significantly increased in colon tumors, while IL-2, IL-15, IL-10, IL-12a, CSF1, HLA-DPA1, HLA-DRA, TNF-a, and CD68 were significantly decreased. Of the eight inflammatory genes consistently increased in tumors, seven (IL-8, IL-23a, IL-1a, IL-1b, IL-17a, INFγ and IL-6) are proinflammatory cytokines and the other (FOXP3) is a marker for regulatory T cells. It is also demonstrated herein that PRG1, IL-10, CD68, IL-23a, and IL-12a expression in noncancerous tissue and PRG1, ANXA1, IL-23a, IL-17a, FOXP3 and HLA-DRA expression in tumor tissues were associated with poor prognosis based on Cox regression (|Z-score|>1.5) and were used to generate the inflammatory risk score (IRS). IRS was associated with cancer-specific mortality. This association was strong for stage II cases (P=0.002). microRNA-21 expression was associated with IL-6, IL-8, IL-10, IL-12a and NOS2a, providing evidence that the function of this microRNA and these inflammatory genes are linked. Both IRS and microRNA-21 expression were independently associated with cancer-specific mortality, including stage II patients alone. Thus, IRS and microRNA-21 expression are independent predictors of colon cancer prognosis and can be used to identify high risk patients.

Based on these results, provided herein are methods for detecting a potentially aggressive colon adenocarcinoma, which allows for predicting the prognosis of a subject diagnosed with colon adenocarcinoma and selecting an appropriate treatment (such as administration of adjunctive therapy). The methods can include (i) quantifying expression of a plurality of inflammatory genes in the colon adenocarcinoma, wherein the plurality of inflammatory genes consists essentially of proteoglycan 1 (PRG1), annexin A1 (ANXA1), interleukin (IL)-17a, IL-23a, forkhead box P3 (FOXP3) and human leukocyte antigen (HLA)-DRA; and (ii) comparing expression of PRG1, ANXA1, IL-17a, IL-23a, FOXP3 and HLA-DRA in the colon adenocarcinoma to a control (e.g., a corresponding non-tumor sample); wherein altered expression of at least one of PRG1, ANXA1, IL-17a, IL-23a, FOXP3 and HLA-DRA in the colon adenocarcinoma compared to the control indicates a more aggressive form of the colon adenocarcinoma.

In some embodiments, the methods further include (i) quantifying expression of a plurality of inflammatory genes in adjacent non-cancerous tissue, wherein the plurality of inflammatory genes consists essentially of PRG1, IL-10, CD68, IL-12a and IL-23a; and (ii) comparing expression of PRG1, IL-10, CD68, IL-12a and IL-23a in the adjacent non-cancerous tissue to a control; wherein altered expression of at least one of PRG1, IL-10, CD68, IL-12a and IL-23a in the non-cancerous tissue compared to the control indicates a more aggressive form of the colon adenocarcinoma.

In some embodiments of the methods, quantifying expression of a plurality of inflammatory genes comprises determining a gene expression signature of the colon adenocarcinoma and/or the adjacent non-cancerous tissue. In some cases, the gene expression signature of the colon adenocarcinoma and/or the non-cancerous tissue is compared to a control gene expression signature. In some embodiments, the methods further include calculating an inflammatory risk score (IRS).

In some embodiments, the methods further include quantifying expression of microRNA-21 (miR-21) in the colon adenocarcinoma and comparing expression of miR-21 in the colon adenocarcinoma to a control. An increase in expression of miR-21 in the colon adenocarcinoma relative to the control predicts an aggressive tumor, such as a tumor with a poor prognosis in which the likelihood of patient mortality is increased.

As described herein, a poor prognosis indicates the subject is a candidate for adjunctive therapy. Thus, methods of selecting a subject as a candidate for adjunctive therapy are also provided.

Further provided are arrays that consist essentially of probes specific for PRG1, ANXA1, IL-17a, IL-23a FOXP3 and HLA-DRA. In some embodiments, the array further includes probes specific for IL-10, CD68 and IL-12a. In some embodiments, the array further includes a probe specific for microRNA-21.

The foregoing and other objects and features of the disclosure will become more apparent from the following detailed description, which proceeds with reference to the accompanying figures.

### BRIEF DESCRIPTION OF THE FIGURES

FIG. 1 is a plot showing that inflammatory genes are consistently altered in colon tumors in both cohorts. Correlation of the tumor/noncancerous tissue expression ratio comparing Hong Kong Cohort with NCI-Maryland cohort indicates consistent changes in inflammatory gene expression in both cohorts.

FIG. 2: Strategy for building inflammatory risk scores. Genes were selected to be included in the risk score based on univariate Cox regression on the Hong Kong Training Cohort. Multivariate Cox regression on the training cohort was used to build the risk models. This model was then tested on the Hong Kong test and Maryland validation cohorts.

FIG. 3: Univariate analysis of the expression of 23 inflammatory genes in noncancerous or tumor tissue with cancer-specific mortality. The genes are ranked based on their predictive power (univariate Z-score). Dashed lines indicate |Z-score|=1.5. Black bars represent |Z-score|>1.5. This criterion was used for selecting genes to include in the multivariate Cox regression model used to calculate IRS.

FIG. 4: Inflammatory risk score (IRS) is associated with cancer specific mortality in TNM stage II patients. (A) IRS in Hong Kong training, Hong Kong test and NCI-Maryland validation cohorts separately. (B) Combined analysis of Hong Kong test and NCI-Maryland validation cohorts, stratified by TNM stage. For 1 patient in the Maryland Cohort, it was unclear if that patient had stage III or stage IV colon cancer and therefore is removed from analyses stratifying by TNM stage.

FIG. 5: Combined Inflammatory Risk Score (IRS) and miR-21 expression predict colon cancer specific mortality better than either alone. All patients from the Hong Kong test and NCI-Maryland validation cohorts are analyzed. Left panel is stratified by miR-21 expression; middle panel is stratified by IRS and miR-21 expression; right panel is combined IRS and miR-21 expression. miR-21 expression data was available for 115 of 117 patients and only those patients were used for this analysis. The Hong Kong training cohort was excluded from this analysis.

### DETAILED DESCRIPTION

. Abbreviations

| | |
|---|---|
| ANXA1 | Annexin A1 |
| CD | Cluster of differentiation |
| cDNA | Complementary DNA |
| CI | Confidence interval |
| CSF1 | Colon stimulating factor 1 |
| DNA | Deoxyribonucleic acid |
| FOXP3 | Forkhead box P3 |
| HLA | Human leukocyte antigen |
| HR | Hazard ratio |
| IFN-γ | Interferon γ |
| IL | Interleukin 1α |
| IRS | Inflammatory risk score |
| MHC | Major histocompatibility complex |
| miR | MicroRNA |
| NOS2A | Nitric oxide synthase 2A |
| PRG1 | Proteoglycan 1 |
| RNA | Ribonucleic acid |
| RT-PCR | Reverse transcriptase polymerase chain reaction |
| SD | Standard deviation |
| TNF-α | Tumor necrosis factor α |
| TNM | Tumor-node-metastasis |

II. Terms

Unless otherwise noted, technical terms are used according to conventional usage. Definitions of common terms in molecular biology may be found in Benjamin Lewin, Genes V, published by Oxford University Press, 1994 (ISBN 0-19-854287-9); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8). All Genbank Accession numbers referenced herein are incorporated by reference for the sequence available on the date listed.

In order to facilitate review of the various embodiments of the disclosure, the following explanations of specific terms are provided:

Adenocarcinoma: Carcinoma derived from glandular tissue or in which the tumor cells form recognizable glandular structures. Adenocarcinomas can be classified according to the predominant pattern of cell arrangement, as papillary, alveolar, etc., or according to a particular product of the cells, as mucinous adenocarcinoma. Adenocarcinomas arise in several tissues, including the colon, kidney, breast, cervix, esophagus, gastric, pancreas, prostate and lung.

Adjacent: As used herein, non-cancerous tissue that is “adjacent” to cancerous tissue refers to non-cancerous tissue in proximity to, such as within the same organ or tissue structure, as the cancerous tissue.

Adjunctive therapy: A treatment used in combination with a primary treatment to improve the effects of the primary treatment. For example, adjunctive therapy includes chemotherapy that is administered following surgical resection of cancerous tissue.

Annexin AI (ANXA1): A molecule that belongs to a family of Ca²⁺-dependent phospholipid binding proteins which have a molecular weight of approximately 35,000 to 40,000 and are preferentially located on the cytosolic face of the plasma membrane. Native annexin I protein has an apparent relative molecular mass of 40 kDa, with phospholipase A2 inhibitory activity. Annexin I may have anti-inflammatory activity.

ANXA1 sequences are publicly available. For example, GENBANK® Accession number NC_{—}000009.10 (deposited Mar. 3, 2006) discloses a human ANXA1 gene sequence, and GENBANK® Accession numbers NM_{—}000700.1 and NP_{—}000691 (each deposited Mar. 24, 1999) disclose human ANXA1 mRNA and protein sequences, respectively. One skilled in the art will appreciate that ANXA1 nucleic acid and protein molecules can vary from those publicly available, such as those having a polymorphism that results in one or more substitutions, deletions, insertions, or combinations thereof, while still retaining ANXA1 biological activity (e.g., increased expression in colon adenocarcinoma indicates poor prognosis).

Array: An arrangement of molecules, such as biological macromolecules (such as peptides or nucleic acid molecules) or biological samples (such as tissue sections), in addressable locations on or in a substrate. A “microarray” is an array that is miniaturized so as to require or be aided by microscopic examination for evaluation or analysis. Arrays are sometimes called DNA chips or biochips.

The array of molecules (“features”) makes it possible to carry out a very large number of analyses on a sample at one time. In certain example arrays, one or more molecules (such as an oligonucleotide probe) will occur on the array a plurality of times (such as twice), for instance to provide internal controls. The number of addressable locations on the array can vary, for example from at least four, to at least 9, at least 10, at least 14, at least 15, at least 20, at least 30, at least 50, at least 75, at least 100, at least 150, at least 200, at least 300, at least 500, least 550, at least 600, at least 800, at least 1000, at least 10,000, or more. In a particular example, an array includes 5-100 addressable locations, such as 5-50 addressable locations. In particular examples, an array consists essentially of probes or primers (such as those that permit amplification) specific for PRG1, IL-10, IL-12a, IL-17a, IL-23a, CD68, ANXA1, FOXP3 and HLA-DRA, and in some examples also miR-21. Such an array can include probes or primers specific for no more than six additional genes (such as 6, 5, 4, 3, 2 or 1 additional genes), such as housekeeping genes.

In particular examples, an array includes nucleic acid molecules, such as oligonucleotide sequences that are at least 15 nucleotides in length, such as about 15-40 nucleotides in length.

Within an array, each arrayed sample is addressable, in that its location can be reliably and consistently determined within at least two dimensions of the array. The feature application location on an array can assume different shapes. For example, the array can be regular (such as arranged in uniform rows and columns) or irregular. Thus, in ordered arrays the location of each sample is assigned to the sample at the time when it is applied to the array, and a key may be provided in order to correlate each location with the appropriate target or feature position. Often, ordered arrays are arranged in a symmetrical grid pattern, but samples could be arranged in other patterns (such as in radially distributed lines, spiral lines, or ordered clusters). Addressable arrays usually are computer readable, in that a computer can be programmed to correlate a particular address on the array with information about the sample at that position (such as hybridization or binding data, including for instance signal intensity). In some examples of computer readable formats, the individual features in the array are arranged regularly, for instance in a Cartesian grid pattern, which can be correlated to address information by a computer.

Protein-based arrays include probe molecules that are or include proteins, or where the target molecules are or include proteins, and arrays including nucleic acids to which proteins are bound, or vice versa. In some examples, an array contains antibodies to at least five different inflammatory molecules.

Candidate: As used herein, a “candidate” for adjunctive therapy is a patient that is likely to respond favorably to therapy. Candidates for adjunctive therapy are typically patients at high risk of disease recurrence, disease progression or death in the absence of additional treatment.

CD68: A 110-kD transmembrane glycoprotein that is highly expressed by human monocytes and tissue macrophages. CD68 is a member of the lysosomal/endosomal-associated membrane glycoprotein (LAMP) family. The protein primarily localizes to lysosomes and endosomes with a smaller fraction circulating to the cell surface. It is a type I integral membrane protein with a heavily glycosylated extracellular domain and binds to tissue- and organ-specific lectins or selectins. CD68 is also a member of the scavenger receptor family. Scavenger receptors typically function to clear cellular debris, promote phagocytosis, and mediate the recruitment and activation of macrophages. Alternative splicing results in multiple transcripts encoding different isoforms.

CD68 sequences are publicly available. For example, GENBANK® Accession numbers NM_{—}001251.2 and NP_{—}001242.2 (each deposited Apr. 6, 2006) disclose human CD68 isoform A mRNA and protein sequences, respectively. GENBANK® Accession numbers NM_{—}00140059.1 and NP_{—}001035148.1 (each deposited Apr. 6, 2006) disclose human CD68 isoform B mRNA and protein sequences, respectively. One skilled in the art will appreciate that CD68 nucleic acid and protein molecules can vary from those publicly available, such as polymorphisms having one or more substitutions, deletions, insertions, or combinations thereof, while still retaining CD68 biological activity (e.g., increased expression in a non-adenocarcinoma tissue sample in a subject having a colon adenocarcinoma indicates poor prognosis).

cDNA (complementary DNA): A piece of DNA lacking internal, non-coding segments (introns) and regulatory sequences which determine transcription. cDNA can be synthesized by reverse transcription from messenger RNA extracted from cells.

Clinical outcome: Refers to the health status of a patient following treatment for a disease or disorder, or in the absence of treatment. Clinical outcomes include, but are not limited to, an increase in the length of time until death, a decrease in the length of time until death, an increase in the chance of survival, an increase in the risk of death, survival, disease-free survival, chronic disease, metastasis, advanced or aggressive disease, disease recurrence, death, and favorable or poor response to therapy.

Colon cancer: Cancer that forms in the tissues of the colon (the longest part of the large intestine). Colon cancer is also referred to as “colorectal cancer.” Most colon cancers are adenocarcinomas (cancers that begin in cells that make line internal organs and have gland-like properties). Cancer progression is characterized by stages, or the extent of cancer in the body. Staging is usually based on the size of the tumor, whether lymph nodes contain cancer, and whether the cancer has spread from the original site to other parts of the body. Stages of colon cancer include stage I, stage II, stage III and stage IV. In some embodiments herein, the colon adenocarcinoma is from any stage. In other embodiments, the colon adenocarcinoma is a stage II cancer.

Colony stimulating factor 1 (CSF-1): A cytokine also known as macrophage colony-stimulating factor. At least four different transcript variants encoding three different isoforms of CSF-1 are known. The human gene for CSF-1 maps to chromosome 1p21-p13 and has 9 exons spanning approximately 19 kb. It is understood that CSF-1 includes both naturally occurring and recombinant CSF-1 peptides, as well as CSF-1 fragments and CSF-1 variants that retain full or partial CSF-1 biological activity.

CSF-1 is produced by macrophages/monocytes, fibroblasts, epithelial, and endothelial cells. It promotes the proliferation, differentiation, and survival of macrophages. It also induces secretion of cytokines and proteases by macrophages. In addition, CSF-1 promotes differentiation and proliferation of osteoclast progenitors.

CSF-1 sequences are publicly available. For example, GENBANK®Accession number NC_{—}000001.9 (deposited Mar. 3, 2006) discloses a human CSF-1 gene sequence, and GENBANK® Accession numbers NM_{—}000757.3, NM_{—}172211.1, NM_{—}172212.1, and NM_{—}172210.1 (each deposited Jan. 30, 2008) disclose known transcript variants of human CSF-1 mRNA sequences. GENBANK® Accession numbers NP_{—}000748 (deposited Apr. 4, 2002), NP_{—}757350 (deposited Dec. 19, 2002), NP_{—}757351 (deposited Dec. 19, 2002), and NP_{—}757349 (deposited Dec. 19, 2002) disclose known isoforms of human CSF-1 protein sequences. One skilled in the art will appreciate that CSF-1 nucleic acid and protein molecules can vary from those publicly available, such as a polymorphism resulting in one or more substitutions, deletions, insertions, or combinations thereof, while still retaining CSF-1 biological activity (e.g., decreased expression in colon adenocarcinoma).

Consists essentially of: In the context of the present disclosure, “consists essentially of” indicates that the expression of additional molecules can be evaluated (such as additional inflammatory genes or controls), but that these molecules do not include more than six other inflammatory genes. Thus, in one example, the expression of a control, such as a housekeeping protein or rRNA can be assessed (such as 18S RNA, beta-microglobulin, GAPDH, and/or 18S rRNA). In some examples, “consist essentially of” indicates that no more than 5 other molecules are evaluated, such as no more than 4, 3, 2, or 1 other molecules. In this context “consist of” indicates that only the expression of the stated molecules are evaluated; the expression of additional molecules is not evaluated.

Control: A “control” refers to a sample or standard used for comparison with an experimental sample, such as a tumor sample obtained from a patient with colon cancer. In some embodiments, the control is a sample obtained from a healthy patient or a non-cancerous tissue sample obtained from a patient diagnosed with colon cancer, such as a non-cancerous tissue sample from the same organ in which the tumor resides (e.g., non-cancerous colon tissue can serve as a control for a colon adenocarcinoma). In some embodiments, the control is a historical control or standard value (i.e., a previously tested control sample or group of samples that represent baseline or normal values, such as the level of miR-21 expression or level of an inflammatory molecule disclosed herein in non-cancerous tissue).

Cytokine/Interleukin (IL): A generic name for a diverse group of soluble proteins and peptides which act as humoral regulators at nano- to picomolar concentrations and which, either under normal or pathological conditions, modulate the functional activities of individual cells and tissues. These proteins also mediate interactions between cells directly and regulate processes taking place in the extracellular environment. Many growth factors and cytokines act as cellular survival factors by preventing programmed cell death. Cytokines and interleukins include both naturally occurring peptides and variants that retain full or partial biological activity. Although specific cytokines/interleukins are described in the specification, they are not limited to the specifically disclosed sequences.

Decrease in survival: As used herein, “decrease in survival” refers to a decrease in the length of time before death of a patient, or an increase in the risk of death for the patient.

Differential expression or altered expression: A difference, such as an increase or decrease, in the conversion of the information encoded in a gene (such as an inflammatory gene) into messenger RNA, the conversion of mRNA to a protein, or both. In some examples, the difference is relative to a control or reference value, such as an amount of gene expression in tissue not affected by a disease, such as an adenocarcinoma (for example colon adenocarcinoma), from the same subject, or an amount expected in a different subject who does not have an adenocarcinoma. The difference can also be in a non-cancerous tissue from a subject (that has the cancer in the same organ) as compared to tissue from a different subject not afflicted with the adenocarcinoma. Detecting differential expression can include measuring a change in gene or protein expression, such as a change in expression of one or more inflammatory genes or proteins, or a microRNA.

Downregulated or decreased: When used in reference to the expression of a nucleic acid molecule (such as an inflammatory gene nucleic acid molecule or a microRNA), refers to any process which results in a decrease in production of a gene product. A gene product can be RNA (such as microRNA, mRNA, rRNA, tRNA, and structural RNA) or protein. Therefore, gene downregulation or deactivation includes processes that decrease transcription of a gene or translation of mRNA.

Examples of processes that decrease transcription include those that facilitate degradation of a transcription initiation complex, those that decrease transcription initiation rate, those that decrease transcription elongation rate, those that decrease processivity of transcription and those that increase transcriptional repression. Gene downregulation can include reduction of expression above an existing level. Examples of processes that decrease translation include those that decrease translational initiation, those that decrease translational elongation and those that decrease mRNA stability.

Gene downregulation includes any detectable decrease in the production of a gene product. In certain examples, production of a gene product decreases by at least 2-fold, for example at least 3-fold or at least 4-fold, as compared to a control (such an amount of gene expression in a normal cell). In several examples, a control is a relative amount of gene expression or protein expression in one or more subjects who do not have a specific adenocarcinoma, such as the relative amount of gene expression or protein expression in “cancer-free” subjects who do not have any known cancer.

Expression: The process by which the coded information of a gene is converted into an operational, non-operational, or structural part of a cell, such as the synthesis of a protein. Gene expression can be influenced by external signals. For instance, exposure of a cell to a hormone may stimulate expression of a hormone-induced gene. Different types of cells can respond differently to an identical signal. Expression of a gene also can be regulated anywhere in the pathway from DNA to RNA to protein. Regulation can include controls on transcription, translation, RNA transport and processing, degradation of intermediary molecules such as mRNA, or through activation, inactivation, compartmentalization or degradation of specific protein molecules after they are produced.

The expression of a nucleic acid molecule (such as a nucleic acid encoding an inflammatory molecule) can be altered, for example relative to expression in a normal (e.g., non-cancerous) sample. Alterations in gene expression, such as differential expression, includes but is not limited to: (1) overexpression; (2) underexpression; or (3) suppression of expression. Alternations in the expression of a nucleic acid molecule can be associated with, and in fact cause, a change in expression of the corresponding protein.

Protein expression (such as expression of an inflammatory gene) can also be altered in some manner to be different from the expression of the protein in a normal (wild type) situation. This includes but is not necessarily limited to: (1) a mutation in the protein such that one or more of the amino acid residues is different; (2) a short deletion or addition of one or a few (such as no more than 10-20) amino acid residues to the sequence of the protein; (3) a longer deletion or addition of amino acid residues (such as at least 20 residues), such that an entire protein domain or sub-domain is removed or added; (4) expression of an increased amount of the protein compared to a control or standard amount; (5) expression of a decreased amount of the protein compared to a control or standard amount; (6) alteration of the subcellular localization or targeting of the protein; (7) alteration of the temporally regulated expression of the protein (such that the protein is expressed when it normally would not be, or alternatively is not expressed when it normally would be); (8) alteration in stability of a protein through increased longevity in the time that the protein remains localized in a cell; and (9) alteration of the localized (such as organ or tissue specific or subcellular localization) expression of the protein (such that the protein is not expressed where it would normally be expressed or is expressed where it normally would not be expressed), each compared to a control or standard. Controls or standards for comparison to a sample, for the determination of differential expression, include samples believed to be normal (in that they are not altered for the desired characteristic, for example a sample from a subject who does not have an adenocarcinoma) as well as laboratory values, even though possibly arbitrarily set. Laboratory standards and values may be set based on a known or determined population value and can be supplied in the format of a graph or table that permits comparison of measured, experimentally determined values.

Forkhead box P3 (FOXP3): A member of the forkhead/winged-helix family of transcriptional regulators. Defects in this gene are the cause of immunodeficiency polyendocrinopathy, enteropathy, X-linked syndrome, also known as X-linked autoimmunity-immunodeficiency syndrome. FOXP3 is also known as scurfin. Alternatively spliced transcript variants encoding different isoforms have been identified.

FOXP3 sequences are publicly available. For example, GENBANK® Accession number NG_{—}007392.1 (deposited Feb. 13, 2008) discloses a human FOXP3 gene sequence. GENBANK® Accession numbers NM_{—}001114377 and NP_{—}001107849.1 (each deposited Feb. 8, 2008) disclose human FOXP3 isoform b mRNA and protein sequences, respectively. GENBANK® Accession numbers NM_{—}014009.3 and NP_{—}054728.2 (each deposited Jun. 19, 2003) disclose human FOXP3 isoform a mRNA and protein sequences, respectively. One skilled in the art will appreciate that FOXP3 nucleic acid and protein molecules can vary from those publicly available, such as polymorphisms resulting in one or more substitutions, deletions, insertions, or combinations thereof, while still retaining FOXP3 biological activity (e.g., increased expression in colon adenocarcinoma and high levels of FOXP3 expression in tumors indicates poor prognosis).

Gene expression profile (or fingerprint or signature): Differential or altered gene expression can be detected by changes in the detectable amount of gene expression (such as cDNA or mRNA) or by changes in the detectable amount of proteins expressed by those genes. A distinct or identifiable pattern of gene expression, for instance a pattern of high and low expression of a defined set of genes or gene-indicative nucleic acids such as ESTs; in some examples, as few as one or two genes provides a profile, but more genes can be used in a profile, for example at least 3, at least 4, at least 5, at least 6, at least 7, at least 9, at least 9 or at least 10. A gene expression profile (also referred to as a fingerprint or signature) can be linked to a tissue or cell type (such as colon tissue), to a particular stage of normal tissue growth or disease progression (such as colon adenocarcinoma), or to any other distinct or identifiable condition that influences gene expression in a predictable way. Gene expression profiles can include relative as well as absolute expression levels of specific genes, and can be viewed in the context of a test sample compared to a baseline or control sample profile (such as a sample from a subject who does not have the cancer of interest). In one example, a gene expression profile in a subject is read on an array (such as a nucleic acid or protein array).

HLA-DPA1: A molecule of the human major histotocompatability complex. HLA-DPA1 sequences are publicly available. For example, GENBANK® Accession number NC_{—}000006.10 (deposited Mar. 3, 2006) discloses a human HLA-DPA1 gene sequence, and GENBANK® Accession numbers NM_{—}033554.2 and NP_{—}291032 (each deposited Nov. 8, 2002) disclose human HLA-DPA1 mRNA and protein sequences, respectively. One skilled in the art will appreciate that HLA-DPA1 nucleic acid and protein molecules can vary from those publicly available, such as polymorphisms resulting in one or more substitutions, deletions, insertions, or combinations thereof, while still retaining HLA-DPA1 biological activity (e.g., decreased expression in colon adenocarcinoma).

HLA-DRA: A molecule of the human major histocompatibility complex. HLA-DRA sequences are publicly available. For example, GENBANK® Accession number NG_{—}002392.2 (deposited Mar. 19, 2003) discloses a human HLA-DRA gene sequence, and GENBANK® Accession numbers NM_{—}019111 and NP_{—}061984.2 (each deposited Sep. 22, 2004) disclose human HLA-DRA mRNA and protein sequences, respectively. One skilled in the art will appreciate that HLA-DRA nucleic acid and protein molecules can vary from those publicly available, such as polymorphisms resulting in one or more substitutions, deletions, insertions, or combinations thereof, while still retaining HLA-DRA biological activity (e.g., increased expression in colon adenocarcinoma indicates poor prognosis).

Inflammatory gene: Refers to any gene that influences inflammatory responses or inflammatory signaling pathways. Inflammatory genes include, but are not limited to, proinflammatory cytokines, anti-inflammatory molecules, transcription factors that regulate inflammatory responses and immune cell signaling molecules.

Inflammatory risk score (IRS): A value based on expression level of one or more inflammatory genes selected from PRG1, ANXA1, IL-17a, IL-23a FOXP3 and HLA-DRA, IL-10, CD68 and IL-12a. In some embodiments, the IRS is calculated by evaluating expression in colon adenocarcinoma tissue. In some examples, the risk is calculated as equal to [(1.321*PRG1)+(0.840*ANXA1)+(0.123*IL-23a)+(0.484*IL-17a)+(0.367*FOXP3)+(−0.373*HLA-DRA)]. In other embodiments, the IRS is calculated by evaluating expression in adjacent non-cancerous tissue. In some examples, the risk based on non-cancerous tissue is calculated as equal to [(0.855*PRG1)+(0.720*IL-10)+(0.458*CD68)+(−0.494*IL-23a)+(−0.635*IL-12a)]. In other embodiments, the IRS is calculated by evaluating the scores from both cancerous and non-cancerous tissues. In some embodiments, subjects with higher than median values for both non-cancerous and cancerous risk scores are considered high risk.

Interferons: A family of more than 15 related proteins with three major classes (α, β, and γ). Viruses are the prototypic inducer of interferon production. Interferons are pleiotropic cellular modulators which induce expression of a wide variety of genes including, but not limited to, chemokines, adhesion proteins, intracellular enzymes, and transcription factors.

Interferon-gamma (IFN-γ): A member of the interferon family. In vivo, interferon-γ is a cytokine that is a dimeric protein glycosylated at two sites with subunits of 146 amino acids, and functional variants thereof. Murine and human IFN-γ have approximately 40% sequence homology at the protein level. The human IFN-γ gene is approximately 6 kb, contains four exons and maps to chromosome 12. At least six different variants of naturally occurring IFN-γ have been described, and differ from each other by variable lengths of the C-terminal ends.

In T helper cells (Th cells) IL2 induces the synthesis of IFN-γ and other cytokines. IFN-γ also stimulates the expression of Ia antigens on the cell surface, the expression of CD4 in T helper cells, and the expression of high-affinity receptors for IgG in myeloid cell lines, neutrophils, and monocytes.

IFN-γ sequences are publicly available. For example, GENBANK® Accession number NC_{—}000012.10 (Mar. 3, 2006) discloses a human IFN-γ gene sequence, and GENBANK® Accession numbers NM_{—}000619.2 and NP_{—}000610 (each deposited Dec. 22, 2004) disclose human IFN-γ mRNA and protein sequences, respectively. One skilled in the art will appreciate that IFN-γ nucleic acid and protein molecules can vary from those publicly available, such as polymorphisms resulting in one or more substitutions, deletions, insertions, or combinations thereof, while still retaining IFN-γ biological activity (e.g., increased expression in colon adenocarcinoma).

Interleukin (IL)-1a: A cytokine that is produced mainly by mononuclear and epithelial cells in response to infection or injury. It induces fever and activation of T-cells and macrophages. IL-1a activates a wide variety of genes involved in the acute phase response, including, but not limited to, other cytokines and cytokine receptors, inflammatory mediators (such as nitric oxide synthase), growth factors (such as fibroblast growth factor, keratinocyte growth factor, and insulin-like growth factor), clotting agents, extracellular matrix molecules, and oncogenes.

In vivo, IL-1a is a cytokine that is found as an 18 kDa monomeric protein of 159 amino acids, and functional variants thereof. Human and murine IL-1a share approximately 62% identity at the amino acid level. Human IL-1a and IL-1b have approximately 22% homology to one another. The gene for IL-1a is localized to chromosome 2q14 and spans approximately 12 kb with 7 exons. IL-1a includes both naturally occurring and recombinant peptides, as well as IL-1a fragments and variants that retain full or partial biological activity.

IL-1a sequences are publicly available. For example, GENBANK® Accession number NC_{—}000002.10 (deposited Mar. 3, 2006) discloses a human IL-1a gene sequence, and GENBANK® Accession numbers NM_{—}000575.3 and NP_{—}000566 (each deposited Jan. 24, 2003) disclose human IL-1a mRNA and protein sequences, respectively. One skilled in the art will appreciate that IL-1a nucleic acid and protein molecules can vary from those publicly available, such as polymorphisms resulting in one or more substitutions, deletions, insertions, or combinations thereof, while still retaining IL-1a biological activity (e.g., increased expression in colon adenocarcinoma).

IL-1b: A cytokine with activities very similar to that of IL-1a. Despite their relatively low homology, they bind to and activate the same receptors. A difference between IL-1a and IL-1b is that IL-1b is not active until its precursor molecule is cleaved and secreted from monocytes, while the precursor form of IL-1a is active and remains intracellular.

In vivo, IL-1b is a cytokine that is found as a monomeric protein of 17 kDa, having a length of 153 amino acids, and functional variants thereof. Human IL-1a and IL-1b have approximately 22% identity. Human and murine IL-1b share approximately 69% identity at the amino acid level. The gene encoding IL-1b maps to chromosome 2q14, spanning approximately 7 kb and having 7 exons.

IL-1b sequences are publicly available. For example, GENBANK® Accession number NC_{—}000002.10 (deposited Mar. 3, 2006) discloses a human IL-1b gene sequence, and GENBANK® Accession numbers NM_{—}000576.2 (deposited Jan. 24, 2003) and NP_{—}000567 (deposited Oct. 17, 2000) disclose human IL-1b mRNA and protein sequences, respectively. One skilled in the art will appreciate that IL-1b nucleic acid and protein molecules can vary from those publicly available, such as those polymorphisms resulting in one or more substitutions, deletions, insertions, or combinations thereof, while still retaining IL-1b biological activity (e.g., increased expression in colon adenocarcinoma).

IL-2: A cytokine that is produced by activated T-cells. It acts primarily as a T-cell growth factor, but B-cells, natural killer cells, and lymphokine-activated killer cells also respond to IL-2.

IL-2 is found in vivo as a 15 kDa glycoprotein having 153 amino acids, and functional variants thereof. Human and murine IL-2 are approximately 63% identical at the amino acid level. The human IL-2 gene maps to chromosome 4q26-q27 and contains 4 exons, spanning approximately 5 kb.

IL-2 sequences are publicly available. For example, GENBANK® Accession number NC_{—}000004.10 (Mar. 3, 2006) discloses a human IL-2 gene sequence, and GENBANK® Accession numbers NM_{—}000586.2 (deposited Feb. 14, 2007) and NP_{—}000577 (deposited Jan. 31, 2003) disclose human IL-2 mRNA and protein sequences, respectively. One skilled in the art will appreciate that IL-2 nucleic acid and protein molecules can vary from those publicly available, such as those having one or more substitutions, deletions, insertions, or combinations thereof, while still retaining IL-2 biological activity (e.g., decreased expression in colon adenocarcinoma).

IL-6: A cytokine having numerous biological activities, which is demonstrated by the many acronyms under which IL6 has been described. For example, IL-6 is also known in the art as interferon, beta 2 (IFNβ2). IL6 is a pro-inflammatory cytokine secreted by T cells and macrophages that influences antigen-specific immune responses and inflammatory reactions.

IL-6 is found in vivo in humans as a protein of 185 amino acids glycosylated at amino acids 73 and 172, and is synthesized as a precursor protein of 212 amino acids. Murine and human IL-6 show 65% sequence homology at the DNA level and 42% homology at the protein level. The human IL-2 gene maps to chromosome 7p21 and contains 5 exons, spanning approximately 5 kb.

IL-6 sequences are publicly available. For example, GENBANK® Accession number AF372214.2 (deposited Jun. 1, 2001) discloses a human IL-6 gene sequence, and GENBANK® Accession numbers BC015511.1 and AAH15511.1 (each deposited Oct. 4, 2001) disclose human IL-6 mRNA and pre-protein sequences, respectively. One skilled in the art will appreciate that IL-6 nucleic acid and protein molecules can vary from those publicly available, such as those polymorphisms resulting in one or more substitutions, deletions, insertions, or combinations thereof, while still retaining IL-6 biological activity (e.g., increased expression in colon adenocarcinoma).

IL-8: A cytokine that is produced by a variety of cells, such as T-cells, monocytes, neutrophils, fibroblasts, and endothelial cells in response to infection or inflammatory stimuli. IL-8 is a potent activator of neutrophils, which follow the IL-8 concentration gradient to the site of infection or inflammation.

IL-8 is found in vivo as a monomeric protein of approximately 8 kDa, and functional variants thereof. At least four forms of IL-8 exist, having 79, 77, 72, and 69 amino acids. IL-8 is a member of the CXC chemokine superfamily. The gene encoding IL-8 maps to chromosome 4q13-q21, and consists of 4 exons spanning approximately 3 kb.

IL-8 sequences are publicly available. For example, GENBANK® Accession number NC_{—}000004.10 (deposited Mar. 3, 2006) discloses a human IL-8 gene sequence, and GENBANK® Accession numbers NM_{—}000584.2 (deposited Feb. 28, 2003) and NP_{—}000575 (deposited Oct. 17, 2000) disclose human IL-8 mRNA and protein sequences, respectively. One skilled in the art will appreciate that IL-8 nucleic acid and protein molecules can vary from those publicly available, such as polymorphisms resulting in one or more substitutions, deletions, insertions, or combinations thereof, while still retaining IL-8 biological activity (e.g., increased expression in colon adenocarcinoma).

IL-10: A cytokine that can inhibit the synthesis of a number of cytokines such as IFN-γ, IL-2 and TNF-β in Tc1 subpopulations of T-cells. This activity can be antagonized by IL-4. IL-10 also inhibits mitogen- or anti-CD3-induced proliferation of T-cells in the presence of accessory cells and reduces the production of IFN-γ and IL-2.

IL-10 is found in vivo as a homodimeric protein with subunits having 160 amino acids, and functional variants thereof. Human IL-10 shows 73% amino acid homology with murine IL-10, and 81% homology with murine IL-10 at the nucleotide level. The human gene for IL-10 maps to chromosome 1q31-q32, has 5 exons, and spans approximately 5 kb.

IL-10 sequences are publicly available. For example, GENBANK® Accession number NC_{—}000001.9 (deposited Mar. 3, 2006) discloses a human IL-10 gene sequence, and GENBANK® Accession numbers NM_{—}000572.2 (deposited Oct. 30, 2002) and NP_{—}000563 (deposited Oct. 17, 2000) disclose human IL-10 mRNA and protein sequences, respectively. One skilled in the art will appreciate that IL-10 nucleic acid and protein molecules can vary from those publicly available, such as polymorphisms resulting in one or more substitutions, deletions, insertions, or combinations thereof, while still retaining IL-10 biological activity (e.g., decreased expression in colon adenocarcinoma and increased expression in corresponding noncancerous tissue predicts poor prognosis).

IL-12: A cytokine that is secreted by peripheral lymphocytes after induction. It is produced mainly by B-cells and to a lesser extent by T-cells. The most powerful inducers of IL-12 are bacteria, bacterial products, and parasites. IL-12 is produced after stimulation with phorbol esters or calcium ionophore by human B-lymphoblastoid cells. IL-12 activates NK-cells positive for CD56, and this activity is blocked by antibodies specific for TNF-alpha.

IL-12 is found in vivo as a heterodimeric 70 kDa glycoprotein consisting of a 35 kDa subunit (IL-12A) and a 40 kDa subunit (IL-12B) linked by disulfide bonds, and functional variants thereof. The human IL-12A gene is localized to chromosome 3p12-q13.2, covers about 7 kb and has seven exons. The human IL-12B gene has 8 exons spanning approximately 15 kb and maps to chromosome 5q31.1-q33.1. Human IL-12A has 60% identity to mouse IL-12A at the amino acid level, while human and mouse IL-12B share approximately 70% identity at the protein level.

IL-12 sequences are publicly available. For example, GENBANK® Accession number NC_{—}000003.10 (deposited Mar. 3, 2006) discloses a human IL-12A gene sequence, and GENBANK® Accession numbers NM_{—}000882.2 and NP_{—}000873 (each deposited Oct. 30, 2002) disclose human IL-12A mRNA and protein sequences, respectively. GENBANK® Accession number NC_{—}000005.8 (deposited Aug. 24, 2004) discloses a human IL-12B gene sequence, while GENBANK® Accession numbers NM_{—}002187.2 and NP_{—}002178 (each deposited Nov. 3, 2002) disclose human IL-12B mRNA and protein sequences, respectively. One skilled in the art will appreciate that IL-12 nucleic acid and protein molecules can vary from those publicly available, such as polymorphisms resulting in one or more substitutions, deletions, insertions, or combinations thereof, while still retaining IL-12 biological activity (e.g., increased expression in corresponding non-cancerous tissue indicates good prognosis of a patient having colon adenocarcinoma).

IL-15: A cytokine that stimulates the proliferation of B-cells, NK cells, and activated CD4+, CD8+ T cells. It is produced by many cells, such as monocytes/macrophages, fibroblasts, keratinocytes, epithelial cells, heart, lung, and liver.

IL-15 is found in vivo as a monomeric protein of 114 amino acids and approximately 18 kDa, and functional variants thereof. The gene for human IL-15 maps to chromosome 4q31, spans approximately 96 kb, and has 8 exons. The mouse and human IL-15 proteins share approximately 72% identity.

IL-15 sequences are publicly available. For example, GENBANK® Accession number NC_{—}000004.10 (deposited Mar. 3, 2006) discloses a human IL-15 gene sequence, and GENBANK® Accession numbers NM_{—}172174.1 (deposited Aug. 29, 2008) and NP_{—}751914 (deposited Dec. 13, 2002) disclose human IL-15 mRNA and protein sequences, respectively. One skilled in the art will appreciate that IL-15 nucleic acid and protein molecules can vary from those publicly available, such as polymorphisms resulting in one or more substitutions, deletions, insertions, or combinations thereof, while still retaining IL-15 biological activity (e.g., decreased expression in colon adenocarcinoma).

IL-17a: A proinflammatory cytokine produced by activated T cells. IL-17a regulates the activities of NF-κB and mitogen-activated protein kinases. This cytokine can stimulate the expression of IL-6 and cyclooxygenase-2, as well as enhance the production of nitric oxide. High levels of IL-17a are associated with several chronic inflammatory diseases including rheumatoid arthritis, psoriasis and multiple sclerosis.

IL-17a sequences are publicly available. For example, GENBANK® Accession number NC_{—}000006.10 (deposited Mar. 3, 2006) discloses a human IL-17a gene sequence, and GENBANK® Accession numbers NM_{—}002190.2 (deposited Jan. 3, 2003) and NP_{—}002181.1 (deposited Mar. 24, 1999) disclose human IL-17a mRNA and protein sequences, respectively. One skilled in the art will appreciate that IL-17a nucleic acid and protein molecules can vary from those publicly available, such as polymorphisms resulting in one or more substitutions, deletions, insertions, or combinations thereof, while still retaining IL-17a biological activity (e.g., increased expression in colon adenocarcinoma indicates poor prognosis).

IL-23a: A subunit of the heterodimeric cytokine IL-23. IL23 is composed of IL-23a and the p40 subunit of interleukin 12 (IL-12B). The receptor for IL-23 is formed by the beta 1 subunit of IL-12R (IL12RB1) and an IL-23 specific subunit, IL23R. Both IL-23 and IL-12 can activate the transcription activator STAT4, and stimulate the production of interferon-gamma. In contrast to IL-12, which acts mainly on naive CD4⁺ T cells, IL-23 preferentially acts on memory CD4⁺ T cells.

IL-23a sequences are publicly available. For example, GENBANK® Accession number NC_{—}000012.10 (deposited Mar. 3, 2006) discloses a human IL-23a gene sequence, and GENBANK® Accession numbers NM_{—}016584.2 (deposited Jan. 30, 2003) and NP_{—}057668.1 (deposited May 4, 2000) disclose human IL-23a mRNA and protein sequences, respectively. One skilled in the art will appreciate that IL-23a nucleic acid and protein molecules can vary from those publicly available, such as those having one or more substitutions, deletions, insertions, or combinations thereof, while still retaining IL-23a biological activity (e.g., increased expression in colon adenocarcinoma indicates poor prognosis and increased expression in corresponding noncancerous tissue predicts good prognosis).

Isolated: An “isolated” biological component (such as a nucleic acid molecule, protein, or cell) has been substantially separated or purified away from other biological components in the cell of the organism, or the organism itself, in which the component naturally occurs, such as other chromosomal and extra-chromosomal DNA and RNA, proteins and cells. Nucleic acid molecules and proteins that have been “isolated” include cytokine molecules (such as DNA or RNA) and proteins purified by standard purification methods. The term also embraces nucleic acid molecules and proteins prepared by recombinant expression in a host cell as well as chemically synthesized nucleic acid molecules and proteins. For example, an isolated cell, such as a colon cancer cell, is one that is substantially separated from other types of cells.

Label: An agent capable of detection, for example by ELISA, spectrophotometry, flow cytometry, or microscopy. For example, a label can be attached to a nucleic acid molecule or protein, thereby permitting detection of the nucleic acid molecule or protein. For example a nucleic acid molecule or an antibody that specifically binds to an inflammatory molecule can include a label. Examples of labels include, but are not limited to, radioactive isotopes, enzyme substrates, co-factors, ligands, chemiluminescent agents, fluorophores, haptens, enzymes, and combinations thereof. Methods for labeling and guidance in the choice of labels appropriate for various purposes are discussed for example in Sambrook et al. (Molecular Cloning: A Laboratory Manual, Cold Spring Harbor, N.Y., 1989) and Ausubel et al. (In Current Protocols in Molecular Biology, John Wiley & Sons, New York, 1998).

Major Histocompatibility Complex: The major histocompatibility complex of humans includes both class I and class II molecules. These include class II, DR alpha (HLA-DRA), which is one of the HLA class II α chain paralogs. This class II molecule is a heterodimer consisting of an alpha and a beta chain, both anchored in the membrane. MHC plays a central role in the immune system by presenting peptides derived from extracellular proteins. Class II molecules are expressed in antigen presenting cells (APC: B lymphocytes, dendritic cells, macrophages). In humans, the alpha chain is approximately 33-35 kDa and its gene contains 5 exons. Exon 1 encodes the leader peptide, exons 2 and 3 encode the two extracellular domains, and exon 4 encodes the transmembrane domain and the cytoplasmic tail. DRA does not have polymorphisms in the peptide binding part and acts as the sole alpha chain for DRB1, DRB3, DRB4 and DRB5.

MicroRNA (miRNA, miR): Single-stranded RNA molecules that regulate gene expression. MicroRNAs are generally 21-23 nucleotides in length. MicroRNAs are processed from primary transcripts known as pri-miRNA to short stem-loop structures called precursor (pre)-miRNA and finally to functional, mature microRNA. Mature microRNA molecules are partially complementary to one or more messenger RNA molecules, and their primary function is to down-regulate gene expression. MicroRNAs regulate gene expression through the RNAi pathway.

MicroRNA-21: A small non-coding RNA located on human chromosome 17. MicroRNA-21 is also known as miR-21, miRNA21 and hsa-mir-21. The expression of miR-21 has been linked to inflammatory responses. Mir-21 expression is increased following lipopolysaccharide-induced inflammation and increased miR-21 expression occurs during T-cell differentiation. Interleukin 6 (IL-6), a proinflammaotory cytokine, can drive miR-21 expression through a STAT3 dependent mechanism.

miR-21 sequences are publicly available, for example, GENBANK® Accession numbers AC004686 (deposited Oct. 14, 2006); BC53563.1 (deposited Jun. 10, 2003) AF480524.1 (deposited May 1, 2002); AJ421741.1 (Dec. 12, 2001); and AY699265.1 (deposited Dec. 21, 2004). One skilled in the art will appreciate that miR-21 nucleic acid molecules can vary from those publicly available, such as polymorphism resulting in one or more substitutions, deletions, insertions, or combinations thereof, while still retaining miR-21 biological activity (e.g., high levels of expression being associated with a worse survival prognosis for stage II or stage III colon adenocarcinoma).

More aggressive: As used herein, a “more aggressive” form of a colon adenocarcinoma is a colon adenocarcinoma with a relatively increased risk of metastasis or recurrence (such as following surgical removal of the tumor). A “more aggressive” colon adenocarcinoma can also refer to a colon adenocarcinoma that confers an increased likelihood of death, or a decrease in the time until death, upon a subject with the colon adenocarcinoma. A subject having a “more aggressive” form of a colon adenocarcinoma is considered high risk (poor prognosis). As described herein, a subject with an aggressive form of colon adenocarcinoma is a candidate for adjunctive therapy.

Patient: As used herein, the term “patient” includes human and non-human animals. The preferred patient for treatment is a human. “Patient” and “subject” are used interchangeably herein.

Pharmaceutically acceptable vehicles: The pharmaceutically acceptable carriers (vehicles) useful in this disclosure are conventional. Remington's Pharmaceutical Sciences, by E. W. Martin, Mack Publishing Co., Easton, Pa., 15th Edition (1975), describes compositions and formulations suitable for pharmaceutical delivery of one or more therapeutic compounds, molecules or agents.

In general, the nature of the carrier will depend on the particular mode of administration being employed. For instance, parenteral formulations usually comprise injectable fluids that include pharmaceutically and physiologically acceptable fluids such as water, physiological saline, balanced salt solutions, aqueous dextrose, glycerol or the like as a vehicle. For solid compositions (for example, powder, pill, tablet, or capsule forms), conventional non-toxic solid carriers can include, for example, pharmaceutical grades of mannitol, lactose, starch, or magnesium stearate. In addition to biologically-neutral carriers, pharmaceutical compositions to be administered can contain minor amounts of non-toxic auxiliary substances, such as wetting or emulsifying agents, preservatives, and pH buffering agents and the like, for example sodium acetate or sorbitan monolaurate.

Preventing, treating or ameliorating a disease: “Preventing” a disease (such as colon adenocarcinoma) refers to inhibiting the full development of a disease. “Treating” refers to a therapeutic intervention that ameliorates a sign or symptom of a disease or pathological condition after it has begun to develop. “Ameliorating” refers to the reduction in the number or severity of signs or symptoms of a disease.

Prognosis: The likelihood of the clinical outcome for a subject afflicted with a specific disease or disorder. With regard to cancer, the prognosis is a representation of the likelihood (probability) that the subject will survive (such as for one, two, three, four or five years) and/or the likelihood (probability) that the tumor will metastasize. A “poor prognosis” indicates a greater than 50% chance that the subject will not survive to a specified time point (such as one, two, three, for or five years), and/or a greater than 50% chance that the tumor will metastasize. In several examples, a poor prognosis indicates that there is a greater than 60%, 70%, 80%, or 90% chance that the subject will not survive and/or a greater than 60%, 70%, 80% or 90% chance that the tumor will metastasize. Conversely, a “good prognosis” indicates a greater than 50% chance that the subject will survive to a specified time point (such as one, two, three, for or five years), and/or a greater than 50% chance that the tumor will not metastasize. In several examples, a good prognosis indicates that there is a greater than 60%, 70%, 80%, or 90% chance that the subject will survive and/or a greater than 60%, 70%, 80% or 90% chance that the tumor will not metastasize.

Proteoglycan 1, secretory granule (PRG1): A molecule also known as a hematopoietic cell granule proteoglycan. Proteoglycans stored in the secretory granules of many hematopoietic cells also contain a protease-resistant peptide core, which may be important for neutralizing hydrolytic enzymes. This encoded protein was found to be associated with the macromolecular complex of granzymes and perforin, which may serve as a mediator of granule-mediated apoptosis.

PRG1 sequences are publicly available. For example, GENBANK® Accession number NC_{—}000010.9 (deposited Mar. 3, 2006) discloses a human PRG1 gene sequence, and GENBANK® Accession numbers NM_{—}002727.2 and NP_{—}002718 (each deposited Apr. 1, 2004) disclose human PRG1 mRNA and protein sequences, respectively. One skilled in the art will appreciate that PRG1 nucleic acid and protein molecules can vary from those publicly available, such as polymorphisms resulting in one or more substitutions, deletions, insertions, or combinations thereof, while still retaining PRG1 biological activity (e.g., increased expression in colon adenocarcinoma indicates poor prognosis and increased expression in corresponding noncancerous tissue indicates poor prognosis).

Purified: The term “purified” does not require absolute purity; rather, it is intended as a relative term. Thus, for example, a purified protein preparation is one in which the protein referred to is more pure than the protein in its natural environment within a cell. For example, a preparation of a protein (such as an inflammatory protein) is purified such that the protein represents at least 50% of the total protein content of the preparation. Similarly, a purified oligonucleotide preparation is one in which the oligonucleotide is more pure than in an environment including a complex mixture of oligonucleotides.

Sample: A biological specimen containing genomic DNA, RNA (including mRNA and microRNA), protein, or combinations thereof, obtained from a subject. Examples include, but are not limited to, peripheral blood, urine, saliva, tissue biopsy, aspirate, surgical specimen, and autopsy material. In one example, a sample includes a biopsy of an adenocarcinoma (such as colon adenocarcinoma), a sample of noncancerous tissue, or a sample of normal tissue (from a subject not afflicted with a known disease or disorder, such as a cancer-free subject).

Therapeutic: A generic term that includes both diagnosis and treatment.

Therapeutic agent: A chemical compound, small molecule, or other composition, such as an antisense compound, antibody, protease inhibitor, hormone, chemokine or cytokine, capable of inducing a desired therapeutic or prophylactic effect when properly administered to a subject. “Incubating” includes a sufficient amount of time for an agent to interact with a cell or tissue. “Contacting” includes incubating an agent in solid or in liquid form with a cell or tissue. “Treating” a cell or tissue with an agent includes contacting or incubating the agent with the cell or tissue.

Therapeutically effective amount: A quantity of a specified pharmaceutical or therapeutic agent sufficient to achieve a desired effect in a subject, or in a cell, being treated with the agent. The effective amount of the agent will be dependent on several factors, including, but not limited to the subject or cells being treated, and the manner of administration of the therapeutic composition.

TNFα: TNFα is primarily secreted by macrophages and exerts pro-inflammatory activity. Local activity of TNFα helps to contain infection, however, when infection spreads to the blood and there is systemic release of TNFα, septic shock and organ failure can occur due to loss of plasma volume as a result of increased vascular permeability. A cytokine found in vivo in humans as a 17 kDa homotrimeric protein with subunits having 157 amino acids, and variants thereof. Human and mouse TNFα have approximately 80% identity at the amino acid level. The human TNFα gene maps to chromosome 6p21.3, has 4 exons, and spans approximately 3 kb.

TNFα sequences are publicly available. For example, GENBANK® Accession number NC_{—}000006.10 (deposited Mar. 3, 2006) discloses a human TNFα gene sequence, and GENBANK® Accession numbers NM_{—}000594.2 and NP_{—}000585 (each deposited Nov. 29, 2002) disclose human TNFα mRNA and protein sequences, respectively. One skilled in the art will appreciate that TNFα nucleic acid and protein molecules can vary from those publicly available, such as polymorphisms resulting in one or more substitutions, deletions, insertions, or combinations thereof, while still retaining TNFα biological activity (e.g., decreased expression in colon adenocarcinoma).

Tumor, neoplasia, malignancy or cancer: The result of abnormal and uncontrolled growth of cells. Neoplasia, malignancy, cancer and tumor are often used interchangeably and refer to abnormal growth of a tissue or cells that results from excessive cell division. The amount of a tumor in an individual is the “tumor burden” which can be measured as the number, volume, or weight of the tumor. A tumor that does not metastasize is referred to as “benign.” A tumor that invades the surrounding tissue and/or can metastasize is referred to as “malignant.” A “non-cancerous tissue” is a tissue from the same organ wherein the malignant neoplasm formed, but does not have the characteristic pathology of the neoplasm. Generally, noncancerous tissue appears histologically normal. A “normal tissue” is tissue from an organ, wherein the organ is not affected by cancer or another disease or disorder of that organ. A “cancer-free” subject has not been diagnosed with a cancer of that organ and does not have detectable cancer.

Tumor-Node-Metastasis (TNM): The TNM classification of malignant tumors is a cancer staging system for describing the extent of cancer in a patient's body. T describes the size of the primary tumor and whether it has invaded nearby tissue; N describes any lymph nodes that are involved; and M describes metastasis. TNM is developed and maintained by the International Union Against Cancer to achieve consensus on one globally recognized standard for classifying the extent of spread of cancer. The TNM classification is also used by the American Joint Committee on Cancer and the International Federation of Gynecology and Obstetrics.

Upregulated or activation: When used in reference to the expression of a nucleic acid molecule, refers to any process which results in an increase in production of a gene product. A gene product can be RNA (such as microRNA mRNA, rRNA, tRNA, and structural RNA) or protein. Therefore, gene upregulation or activation includes processes that increase transcription of a gene or translation of mRNA, such as an inflammatory gene.

Examples of processes that increase transcription include those that facilitate formation of a transcription initiation complex, those that increase transcription initiation rate, those that increase transcription elongation rate, those that increase processivity of transcription and those that relieve transcriptional repression (for example by blocking the binding of a transcriptional repressor). Gene upregulation can include inhibition of repression as well as stimulation of expression above an existing level. Examples of processes that increase translation include those that increase translational initiation, those that increase translational elongation and those that increase mRNA stability.

Gene upregulation includes any detectable increase in the production of a gene product, such as an inflammatory gene. In certain examples, production of a gene product increases by at least 2-fold, for example at least 3-fold, at least 4-fold, at least 5-fold, at least 8-fold, at least 10-fold, or at least 15-fold, as compared to a control (such an amount of gene expression in a normal cell).

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Hence “comprising A or B” means including A, or B, or A and B. It is further to be understood that all base sizes or amino acid sizes, and all molecular weight or molecular mass values, given for nucleic acids or polypeptides are approximate, and are provided for description. Although methods and materials similar or equivalent to those described herein can be used in the practice or testing of the present disclosure, suitable methods and materials are described below. In case of conflict, the present specification, including explanations of terms, will control. In addition, the materials, methods, and examples are illustrative only and not intended to be limiting.

III. Overview of Several Embodiments

Inflammation participates in the development and progression of a number of different diseases, including cancer. Inflammatory gene expression profiles have proved useful for diagnosis and prognosis of some types of cancer, such as hepatocellular carcinoma and lung cancer. However, there remains a need to identify biomarkers useful for predicting prognosis of patients with colon adenocarcinoma. The ability to classify colon cancer patients as high risk (poor prognosis) or low risk (favorable prognosis) would enable selection of appropriate therapies for these patients. For example, high risk patients are likely to benefit from aggressive therapy, whereas therapy may have no significant advantage for low risk patients and furthermore, therapy is likely to hinder quality of life for low risk patients. However, in spite of this need, a solution to this problem has not been available.

It is disclosed herein that altered expression of particular inflammatory genes in colon adenocarcinoma tissue and/or adjacent non-cancerous tissue is indicative of a poor prognosis (such as an increased likelihood of death) for colon adenocarcinoma patients (such as those having stage II colon adenocarcinoma). Thus, inflammatory gene signatures can be used to detect a more aggressive form of colon adenocarcinoma, predict prognosis of a subject diagnosed with colon adenocarcinoma and select appropriate anti-tumor therapies for colon adenocarcinoma patients. It is also described herein that an increase in expression of microRNA-21 (miR-21) in colon adenocarcinoma relative to a control is an independent indicator of a poor prognosis. Furthermore, combining the two types of biomarkers provides better predictive power than either alone.

The methods provided herein can be used to detect a more aggressive form of a colon adenocarcinoma in a patient, thereby predicting the prognosis of the patient and enabling selection of an appropriate therapy (such as adjunctive therapy). In the context of the present disclosure, “poor prognosis” includes, for example, a decrease in the likelihood of survival, a decrease in time until death or an increase in disease progression or recurrence. Patients with a poor prognosis are considered high risk and are most likely to benefit from adjunctive therapy. Thus, a poor prognosis (as determined by detection of a more aggressive form or colon adenocarcinoma) indicates the patient is a candidate for adjunctive therapy.

Provided herein are methods for detecting a more aggressive form of colon adenocarcinoma which allows for predicting the prognosis of a subject diagnosed with the colon adenocarcinoma and selecting an appropriate treatment (such as adjunctive therapy). The methods can include (i) quantifying expression of a plurality of inflammatory genes in the colon adenocarcinoma, wherein the plurality of inflammatory genes consists essentially of proteoglycan 1 (PRG1), annexin A1 (ANXA1), interleukin (IL)-17a, IL-23a, forkhead box P3 (FOXP3) and human leukocyte antigen (HLA)-DRA; and (ii) comparing expression of PRG1, ANXA1, IL-17a, IL-23a, FOXP3 and HLA-DRA in the colon adenocarcinoma to a control; wherein altered expression these expression values in the colon adenocarcinoma compared to the control can indicate a more aggressive form of the colon adenocarcinoma. For example, the expression values can be used to generate an inflammatory risk score (IRS) as described below. High inflammatory risk score indicates poor prognosis.

In some embodiments, altered expression of at least two, at least three, at least four, at least five or each of PRG1, ANXA1, IL-17a, IL-23a FOXP3 and HLA-DRA in the colon adenocarcinoma compared to the control indicates a more aggressive form of the colon adenocarcinoma. In some examples, altered expression is an increase in expression, such as an increase of at least 2-fold, at least 3-fold, at least 4-fold, at least 5-fold, at least 6-fold, at least 7-fold, at least 8-fold, at least 10-fold, at least 12-fold, for example 2 to 20-fold, 2- to 15-fold, or 2- to 13-fold, relative to a control (such as expression in adjacent non-cancerous tissue or a value or range of values expected for such a sample). In some examples, an increase in expression indicates a more aggressive form of the colon adenocarcinoma.

In some embodiments, the method further includes (i) quantifying expression of a plurality of inflammatory genes in adjacent non-cancerous tissue, wherein the plurality of inflammatory genes consists essentially of PRG1, IL-10, CD68, IL-12a and IL-23a; and (ii) comparing expression of PRG1, IL-10, CD68, IL-12a and IL-23a in the adjacent non-cancerous tissue to a control (such as a reference value or range of values representing expression expected in normal colon tissue or control RNA extracted from normal colon tissue); wherein altered expression of at least one of PRG1, IL-10, CD68, IL-12a and IL-23a in the non-cancerous tissue compared to the control indicates a more aggressive form of the colon adenocarcinoma. In some embodiments, altered expression is an increase in expression. In some embodiments, altered expression is a decrease in expression.

In some embodiments, altered expression of PRG1, IL-10, CD68 or a combination thereof is an increase in expression PRG1, IL-10, CD68 or a combination thereof. In some examples, an increase in expression of PRG1, IL-10, CD68 or a combination thereof in the adjacent non-cancerous tissue relative to the control indicates a more aggressive form of the colon adenocarcinoma. For example, an increase in expression of PRG1, IL-10, CD68 or a combination thereof in the adjacent non-cancerous tissue, such as an increase of at least 2-fold, at least 3-fold, at least 4-fold, at least 5-fold, at least 6-fold, at least 7-fold, at least 8-fold, at least 10-fold, at least 12-fold, for example 2 to 20-fold, 2- to 15-fold, or 2- to 13-fold, relative to a control (such as a reference value or range of values representing expression expected in normal colon tissue or control RNA extracted from normal colon tissue) indicates a more aggressive form of the colon adenocarcinoma. In some embodiments, altered expression of IL-12a, IL-23a or both is a decrease in expression of IL-12a, IL-23a or both. In some examples, a decrease in expression of IL-12a, IL-23a or both in the adjacent non-cancerous tissue relative to the control indicates a more aggressive form of the colon adenocarcinoma. For example, a decrease in expression of IL-12a, IL-23a or both in the adjacent non-cancerous tissue, such as an decrease of at least 10%, at least 20%, at least 30%, at least 40%, at least 50%, at least 60%, at least 70%, at least 80%, at least 90%, for example 20% to 99%, 25 to 95%, or 25% to 90%, relative to a control (such as a reference value or range of values representing expression expected in normal colon tissue or control RNA extracted from normal colon tissue) indicates a more aggressive form of the colon adenocarcinoma.

In particular embodiments of the methods provided herein, an increase in expression of PRG1, ANXA1, IL-17a, IL-23a FOXP3 and HLA-DRA in the colon adenocarcinoma relative to the control, an increase in expression of PRG1, IL-10 and CD68 in the adjacent non-cancerous tissue relative to the control, and a decrease in expression of IL-12a and IL-23a in the adjacent non-cancerous tissue relative to the control, indicates a more aggressive form of the colon adenocarcinoma. In some examples the control is a reference value or range of values representing expression expected in normal colon tissue or control RNA extracted from normal colon tissue.

The colon adenocarcinoma can be at any stage (such as stage I, stage II, stage III or stage IV). In some embodiments, the colon adenocarcinoma is a stage II colon adenocarcinoma.

In some embodiments of the methods, quantifying expression of a plurality of inflammatory genes includes determining a gene expression signature of the colon adenocarcinoma and/or the adjacent non-cancerous tissue. In some cases, the gene expression signature of the colon adenocarcinoma and/or the non-cancerous tissue is compared to a control gene expression signature. The control gene expression signature can be obtained from any type of suitable control, such as colon tissue obtained from a healthy subject. In some cases, the control gene expression signature is based on a reference standard, such as an average of historical controls. In some embodiments, the gene expression signature includes a plurality of inflammatory genes selected from PRG1, ANXA1, IL-17a, IL-23a, FOXP3 and HLA-DRA, CD68, IL-10 and IL-12a.

In some embodiments, the methods further include calculating an inflammatory risk score (IRS). The IRS is a value based on an expression level of one or more inflammatory genes selected from PRG1, ANXA1, IL-17a, IL-23a FOXP3 and HLA-DRA, IL-10, CD68 and IL-12a. In some embodiments, the IRS is calculated by evaluating expression in colon adenocarcinoma tissue. In some examples, the risk is calculated as equal to [(1.321*PRG1)+(0.840*ANXA1)+(0.123*IL-23a)+(0.484*IL-17a)+(0.367*FOXP3)+(−0.373*HLA-DRA)]. In other embodiments, the IRS is calculated by evaluating expression in adjacent non-cancerous tissue. In some examples, the risk based on non-cancerous tissue is calculated as equal to [(0.855*PRG1)+(0.720*IL-10)+(0.458*CD68)+(−0.494*IL-23a)+(−0.635*IL-12a)]. In other embodiments, the IRS is calculated by evaluating the scores from both cancerous and non-cancerous tissues.

In some embodiments, subjects with higher than median values for the non-cancerous risk score, the cancerous risk score, or both, are predicted to have a poor prognosis (at high risk). In the studies described herein, median risk values were calculated separately for each cohort using all samples in that cohort. The risk equation was calculated from one of the cohorts (the Hong Kong training cohort). The risk score was calculated as the summed products of gene expression values multiplied by derived coefficient from the risk equation. Subjects with a risk score value greater than the median value for that cohort were considered high in the examples described herein. It is also contemplated herein that a subject's inflammatory gene expression profile and inflammatory risk score can be compared to the expression profile and risk score of a referent sample to determine if the subject's risk score is high or low. The referent sample can be any appropriate control sample, such as a sample obtained from the colon of a healthy subject. The referent sample can also be a standard value, such as a standard value based on the average of historical values. Thus, in some embodiments, a subject with a higher cancerous risk score, non-cancerous risk score, or both, than the referent sample is considered to have a poor prognosis (high risk).

In some embodiments, the plurality of inflammatory genes further includes one or more of IL-1a, IL-1b, IL-2, IL-6, IL-8, IL-12b, IL-15, tumor necrosis factor (TNF)-α, interferon (IFN)-γ, colony stimulating factor (CSF)-1, HLA-DPA1 and nitric oxide synthase 2A (NOS2A). For example, increased expression of IL-1a, IL-1b, IL-6, IL-8, IFN-γ, or combinations thereof, and/or decreased expression of IL-2, IL-15, TNF-α, CSF-1, HLA-DPA1, or combinations thereof in a colon adenocarcinoma sample relative to an adjacent non-cancerous sample indicates a poor prognosis.

In some embodiments, the methods further include quantifying expression of microRNA-21 (miR-21) in the colon adenocarcinoma and comparing expression of miR-21 in the colon adenocarcinoma to a control (such as a reference value or range of values representing expression expected in normal colon tissue or control RNA extracted from normal colon tissue). In some embodiments, an increase in expression of miR-21 in the colon adenocarcinoma relative to the control indicates a more aggressive form of the colon adenocarcinoma. In some examples, expression of miR-21 is increased at least 2-fold, at least 3-fold or at least 4-fold in the colon adenocarcinoma relative to the control.

In particular examples, the method for detecting a more aggressive form of a colon adenocarcinoma includes (i) quantifying expression of a plurality of inflammatory genes in the colon adenocarcinoma and in adjacent non-cancerous tissue, wherein the plurality of inflammatory genes consists essentially of proteoglycan 1 (PRG1), interleukin (IL)-10, IL-12a, IL-17a, IL-23a, CD68, annexin A1 (ANXA1), forkhead box p3 (FOXP3) and human leukocyte antigen (HLA)-DRA; and (ii) comparing expression of PRG1, ANXA1, IL-17a, IL-23a FOXP3 and HLA-DRA in the colon adenocarcinoma and expression of PRG1, IL-10, CD68, IL-12a and IL-23a in the adjacent non-cancerous tissue to a control (such as a reference value or range of values representing expression expected in normal colon tissue or control RNA extracted from normal colon tissue); wherein altered expression of at least one of PRG1, ANXA1, IL-17a, IL-23a FOXP3 and HLA-DRA in the colon adenocarcinoma, and altered expression of at least one of PRG1, IL-10, CD68, IL-12a and IL-23a in the non-cancerous tissue, compared to the control indicates a more aggressive form of the colon adenocarcinoma. In this example, an increase in expression of PRG1, ANXA1, IL-17a, IL-23a FOXP3 and HLA-DRA in the colon adenocarcinoma relative to the control, an increase in expression of PRG1, IL-10 and CD68 in the adjacent non-cancerous tissue relative to the control, and a decrease in expression of IL-12a and IL-23a in the adjacent non-cancerous tissue relative to the control indicates a more aggressive form of the colon adenocarcinoma. The values obtained from detecting expression levels of the inflammatory genes can be used to generate a gene expression signature for the particular adenocarcinoma. The gene expression signature can then be used to evaluate risk of the patient. In some cases, the gene expression signature is compared to a control gene expression signature, such as a gene expression signature from a healthy colon tissue sample.

As described herein, detecting a more aggressive form of a colon adenocarcinoma (a poor prognosis) in a subject indicates the subject is a candidate for adjunctive therapy. Thus, methods of selecting a subject as a candidate for adjunctive therapy are also provided. In one example, the method for selecting a subject diagnosed with colon adenocarcinoma as a candidate for adjunctive therapy comprises (i) quantfying expression of a plurality of inflammatory genes in the colon adenocarcinoma and in adjacent non-cancerous tissue, wherein the plurality of inflammatory genes consists essentially of PRG1, IL-10, IL-12a, IL-17a, IL-23a, CD68, ANXA1, FOXP3 and HLA-DRA; and (ii) comparing expression of PRG1, ANXA1, IL-17a, IL-23a FOXP3 and HLA-DRA in the colon adenocarcinoma and expression of PRG1, IL-10, CD68, IL-12a and IL-23a in the adjacent non-cancerous tissue to a control; wherein an increase in expression of PRG1, ANXA1, IL-17a, IL-23a FOXP3 and HLA-DRA in the colon adenocarcinoma relative to the control, an increase in expression of PRG1, IL-10 and CD68 in the adjacent non-cancerous tissue relative to the control, and a decrease in expression of IL-12a and IL-23a in the adjacent non-cancerous tissue relative to the control indicates the subject is a candidate for adjunctive therapy. In some examples of this method, the colon adenocarcinoma is a stage II colon adenocarcinoma.

Adjunctive therapy can be any type of appropriate therapy known in the art. Common adjunctive therapies for cancer include chemotherapy and radiation treatment. Adjunctive therapy is often given following surgical removal of tumor tissue.

A subject having a more aggressive form of a colon adenocarcinoma is considered to have a poor prognosis. In the context of the present disclosure, a “poor prognosis” can refer to a decrease in the likelihood of survival, a decrease in time until death or disease progression. Patients with a poor prognosis are considered high risk (such as determined by the inflammatory risk score).

Control samples used in the disclosed methods can any control suitable for comparison. In some embodiments, the control is colon tissue obtained from a healthy subject. In other embodiments, the control is a standard value. For example, the standard value can be derived from average expression values of non-cancerous colon tissue. In some embodiments, the control is non-cancerous tissue obtained from the subject.

Further provided are arrays that consist essentially of probes specific for PRG1, ANXA1, IL-17a, IL-23a FOXP3 and HLA-DRA. In some embodiments, the array further includes probes specific for IL-10, CD68 and IL-12a. In some embodiments, the array further includes a probe specific for microRNA-21. Such arrays can include probes specific for 1 to 5 housekeeping genes. In a particular example, the array consists of probes specific for PRG1, ANXA1, IL-17a, IL-23a FOXP3, HLA-DRA, IL-10, CD68, IL-12a, microRNA-21, and 0 to 5 housekeeping genes.

IV. Detection of Inflammatory Gene Expression

As described below, expression of one or more inflammatory genes can be detected using any one of a number of methods well known in the art. Expression of either mRNA or protein is contemplated herein.

Methods for detection of mRNA

Inflammatory gene expression can be evaluated by detecting mRNA encoding the inflammatory gene of interest. Thus, the disclosed methods can include evaluating mRNA encoding PRG1, IL-10, IL-12a, IL-17a, IL-23a, CD68, ANXA1, FOXP3 and HLA-DRA. In some embodiments, the methods provided herein further include evaluating expression of microRNA, such as miR-21. In some examples, the mRNA is quantified.

RNA can be isolated from a sample of a colon adenocarcinoma from a subject, a sample of adjacent non-cancerous tissue from the subject, from cancer-free tissue from a normal (healthy) subject, or combinations thereof, using methods well known to one skilled in the art, including commercially available kits. General methods for mRNA extraction are well known in the art and are disclosed in standard textbooks of molecular biology, including Ausubel et al., Current Protocols of Molecular Biology, John Wiley and Sons (1997). Methods for RNA extraction from paraffin embedded tissues are disclosed, for example, in Rupp and Locker, Lab Invest. 56:A67 (1987), and De Andres et al., BioTechniques 18:42044 (1995). In one example, RNA isolation can be performed using purification kit, buffer set and protease from commercial manufacturers, such as QIAGEN®, according to the manufacturer's instructions. For example, total RNA from cells in culture (such as those obtained from a subject) can be isolated using QIAGIN® RNeasy mini-columns Other commercially available RNA isolation kits include MASTERPURE®. Complete DNA and RNA Purification Kit (EPICENTRE® Madison, Wis.), and Paraffin Block RNA Isolation Kit (Ambion, Inc.). Total RNA from tissue samples can be isolated using RNA Stat-60 (Tel-Test). RNA prepared from tumor or other biological sample can be isolated, for example, by cesium chloride density gradient centrifugation.

Methods of gene expression profiling include methods based on hybridization analysis of polynucleotides, methods based on sequencing of polynucleotides, and proteomics-based methods. In some examples, mRNA expression in a sample is quantified using northern blotting or in situ hybridization (Parker & Barnes, Methods in Molecular Biology 106:247-283, 1999); RNAse protection assays (Hod, Biotechniques 13:852-4, 1992); and PCR-based methods, such as reverse transcription polymerase chain reaction (RT-PCR) (Weis et al., Trends in Genetics 8:263-4, 1992). Alternatively, antibodies can be employed that can recognize specific duplexes, including DNA duplexes, RNA duplexes, and DNA-RNA hybrid duplexes or DNA-protein duplexes. Representative methods for sequencing-based gene expression analysis include Serial Analysis of Gene Expression (SAGE), and gene expression analysis by massively parallel signature sequencing (MPSS). In one example, RT-PCR can be used to compare mRNA levels in different samples, in normal and tumor tissues, with or without drug treatment, to characterize patterns of gene expression, to discriminate between closely related mRNAs, and to analyze RNA structure.

Methods for quantitating mRNA are well known in the art. In one example, the method utilizes RT-PCR. Generally, the first step in gene expression profiling by RT-PCR is the reverse transcription of the RNA template into cDNA, followed by its exponential amplification in a PCR reaction. Two commonly used reverse transcriptases are avian myeloblastosis virus reverse transcriptase (AMV-RT) and Moloney murine leukemia virus reverse transcriptase (MMLV-RT). The reverse transcription step is typically primed using specific primers, random hexamers, or oligo-dT primers, depending on the circumstances and the goal of expression profiling. For example, extracted RNA can be reverse-transcribed using a GeneAmp RNA PCR kit (Perkin Elmer, Calif., USA), following the manufacturer's instructions. The derived cDNA can then be used as a template in the subsequent PCR reaction.

Although the PCR step can use a variety of thermostable DNA-dependent DNA polymerases, it typically employs the Taq DNA polymerase. TaqMan® PCR typically utilizes the 5′-nuclease activity of Taq or Tth polymerase to hydrolyze a hybridization probe bound to its target amplicon, but any enzyme with equivalent 5′ nuclease activity can be used. Two oligonucleotide primers are used to generate an amplicon typical of a PCR reaction. A third oligonucleotide, or probe, is designed to detect nucleotide sequence located between the two PCR primers. The probe is non-extendible by Taq DNA polymerase enzyme, and is labeled with a reporter fluorescent dye and a quencher fluorescent dye. Any laser-induced emission from the reporter dye is quenched by the quenching dye when the two dyes are located close together as they are on the probe. During the amplification reaction, the Taq DNA polymerase enzyme cleaves the probe in a template-dependent manner. The resultant probe fragments disassociate in solution, and signal from the released reporter dye is free from the quenching effect of the second fluorophore. One molecule of reporter dye is liberated for each new molecule synthesized, and detection of the unquenched reporter dye provides the basis for quantitative interpretation of the data.

TAQMAN® RT-PCR can be performed using commercially available equipment, such as, for example, ABI PRISM 7700® Sequence Detection System®(Perkin-Elmer-Applied Biosystems, Foster City, Calif.), or Lightcycler (Roche Molecular Biochemicals, Mannheim, Germany). In one example, the 5′ nuclease procedure is run on a real-time quantitative PCR device such as the ABI PRISM 7700® Sequence Detection System®. The system includes of thermocycler, laser, charge-coupled device (CCD), camera and computer. The system amplifies samples in a 96-well format on a thermocycler. During amplification, laser-induced fluorescent signal is collected in real-time through fiber optics cables for all 96 wells, and detected at the CCD. The system includes software for running the instrument and for analyzing the data.

To minimize errors and the effect of sample-to-sample variation, RT-PCR can be performed using an internal standard. The ideal internal standard is expressed at a constant level among different tissues, and is unaffected by the experimental treatment. RNAs commonly used to normalize patterns of gene expression are mRNAs for the housekeeping genes glyceraldehyde-3-phosphate-dehydrogenase (GAPDH), beta-actin, and 18S ribosomal RNA.

A variation of RT-PCR is real time quantitative RT-PCR, which measures PCR product accumulation through a dual-labeled fluorigenic probe (e.g. TAQMAN® probe). Real time PCR is compatible both with quantitative competitive PCR, where internal competitor for each target sequence is used for normalization, and with quantitative comparative PCR using a normalization gene contained within the sample, or a housekeeping gene for RT-PCR (see Held et al., Genome Research 6:986 994, 1996). Quantitative PCR is also described in U.S. Pat. No. 5,538,848. Related probes and quantitative amplification procedures are described in U.S. Pat. No. 5,716,784 and U.S. Pat. No. 5,723,591. Instruments for carrying out quantitative PCR in microtiter plates are available from PE Applied Biosystems, 850 Lincoln Centre Drive, Foster City, Calif. 94404 under the trademark ABI PRISM® 7700.

The steps of a representative protocol for quantitating gene expression using fixed, paraffin-embedded tissues as the RNA source, including mRNA isolation, purification, primer extension and amplification are given in various published journal articles (see Godfrey et al., J. Mol. Diag. 2:84 91, 2000; Specht et al., Am. J. Pathol. 158:419-29, 2001, herein incorporated by reference). Briefly, a representative process starts with cutting about 10 μm thick sections of paraffin-embedded tumor tissue samples or adjacent non-cancerous tissue. The RNA is then extracted, and protein and DNA are removed. Alternatively, RNA is located directly from a tumor sample and adjacent non-cancerous tissue. After analysis of the RNA concentration, RNA repair and/or amplification steps can be included, if necessary, and RNA is reverse transcribed using gene specific promoters followed by RT-PCR. The primers used for the amplification are selected so as to amplify a unique segment of the gene of interest, such as mRNA encoding PRG1, IL-10, IL-12a, IL-17a, IL-23a, CD68, ANXA1, FOXP3 and HLA-DRA. In some embodiments, expression of miR-21 is also detected. Primers that can be used to amplify PRG1, IL-10, IL-12a, IL-17a, IL-23a, CD68, ANXA1, FOXP3, HLA-DRA and miR-21 are commercially available or can be designed and synthesized according to well known methods.

An alternative quantitative nucleic acid amplification procedure is described in U.S. Pat. No. 5,219,727. In this procedure, the amount of a target sequence in a sample is determined by simultaneously amplifying the target sequence and an internal standard nucleic acid segment. The amount of amplified DNA from each segment is determined and compared to a standard curve to determine the amount of the target nucleic acid segment that was present in the sample prior to amplification.

In some embodiments of this method, the expression of a “house keeping” gene or “internal control” can also be evaluated. These terms include any constitutively or globally expressed gene whose presence enables an assessment of inflammatory gene mRNA levels. Such an assessment includes a determination of the overall constitutive level of gene transcription and a control for variations in RNA recovery.

In some examples, gene expression is identified or confirmed using the microarray technique. Thus, the expression profile can be measured in either fresh or paraffin-embedded tumor tissue, using microarray technology. In this method, inflammatory gene or microRNA nucleic acid sequences of interest (including cDNAs and oligonucleotides) are plated, or arrayed, on a microchip substrate. The arrayed sequences are then hybridized with specific DNA probes from cells or tissues of interest. Just as in the RT-PCR method, the source of mRNA typically is total RNA isolated from human tumors, and corresponding noncancerous tissue and normal tissues or cell lines.

In a specific embodiment of the microarray technique, PCR amplified inserts of cDNA clones are applied to a substrate in a dense array. At least probes PRG1, IL-10, IL-12a, IL-17a, IL-23a, CD68, ANXA1, FOXP3 and HLA-DRA nucleotide sequences are applied to the substrate, and the array can consist essentially of, or consist of these sequences. In some embodiments, the array further includes a probe for miR-21. The microarrayed nucleic acids are suitable for hybridization under stringent conditions. Fluorescently labeled cDNA probes may be generated through incorporation of fluorescent nucleotides by reverse transcription of RNA extracted from tissues of interest. Labeled cDNA probes applied to the chip hybridize with specificity to each spot of DNA on the array. After stringent washing to remove non-specifically bound probes, the chip is scanned by confocal laser microscopy or by another detection method, such as a CCD camera. Quantitation of hybridization of each arrayed element allows for assessment of corresponding mRNA abundance. With dual color fluorescence, separately labeled cDNA probes generated from two sources of RNA are hybridized pairwise to the array. The relative abundance of the transcripts from the two sources corresponding to each specified gene is thus determined simultaneously. The miniaturized scale of the hybridization affords a convenient and rapid evaluation of the expression pattern for PRG1, IL-10, IL-12a, IL-17a, IL-23a, CD68, ANXA1, FOXP3, HLA-DRA and miR-21. Such methods have been shown to have the sensitivity required to detect rare transcripts, which are expressed at a few copies per cell, and to reproducibly detect at least approximately two-fold differences in the expression levels (Schena et al., Proc. Natl. Acad. Sci. USA 93(2):10614-9, 1996). Microarray analysis can be performed by commercially available equipment, following manufacturer's protocols, such as are supplied with Affymetrix GenChip technology, or Incyte's microarray technology.

Serial analysis of gene expression (SAGE) is another method that allows the simultaneous and quantitative analysis of a large number of gene transcripts, without the need of providing an individual hybridization probe for each transcript. First, a short sequence tag (about 10-14 base pairs) is generated that contains sufficient information to uniquely identify a transcript, provided that the tag is obtained from a unique position within each transcript. Then, many transcripts are linked together to form long serial molecules, that can be sequenced, revealing the identity of the multiple tags simultaneously. The expression pattern of any population of transcripts can be quantitatively evaluated by determining the abundance of individual tags, and identifying the gene corresponding to each tag (see, for example, Velculescu et al., Science 270:484-7, 1995; and Velculescu et al., Cell 88:243-51, 1997, herein incorporated by reference).

In situ hybridization (ISH) is another method for detecting and comparing expression of genes of interest. ISH applies and extrapolates the technology of nucleic acid hybridization to the single cell level, and, in combination with the art of cytochemistry, immunocytochemistry and immunohistochemistry, permits the maintenance of morphology and the identification of cellular markers to be maintained and identified, and allows the localization of sequences to specific cells within populations, such as tissues and blood samples. ISH is a type of hybridization that uses a complementary nucleic acid to localize one or more specific nucleic acid sequences in a portion or section of tissue (in situ), or, if the tissue is small enough, in the entire tissue (whole mount ISH). RNA ISH can be used to assay expression patterns in a tissue, such as the expression of inflammatory genes or microRNAs.

Sample cells or tissues are treated to increase their permeability to allow a probe, such as an inflammatory gene-specific probe, to enter the cells. The probe is added to the treated cells, allowed to hybridize at pertinent temperature, and excess probe is washed away. A complementary probe is labeled with a radioactive, fluorescent or antigenic tag, so that the probe's location and quantity in the tissue can be determined using autoradiography, fluorescence microscopy or immunoassay. The sample may be any sample as herein described, such as a non-cancerous or colon adenocarcinoma sample. Since the sequences of the inflammatory genes of interest are known, probes can be designed accordingly such that the probes specifically bind the gene of interest.

In situ PCR is the PCR based amplification of the target nucleic acid sequences prior to ISH. For detection of RNA, an intracellular reverse transcription step is introduced to generate complementary DNA from RNA templates prior to in situ PCR. This enables detection of low copy RNA sequences.

Prior to in situ PCR, cells or tissue samples are fixed and permeabilized to preserve morphology and permit access of the PCR reagents to the intracellular sequences to be amplified. PCR amplification of target sequences is next performed either in intact cells held in suspension or directly in cytocentrifuge preparations or tissue sections on glass slides. In the former approach, fixed cells suspended in the PCR reaction mixture are thermally cycled using conventional thermal cyclers. After PCR, the cells are cytocentrifuged onto glass slides with visualization of intracellular PCR products by ISH or immunohistochemistry. In situ PCR on glass slides is performed by overlaying the samples with the PCR mixture under a coverslip which is then sealed to prevent evaporation of the reaction mixture. Thermal cycling is achieved by placing the glass slides either directly on top of the heating block of a conventional or specially designed thermal cycler or by using thermal cycling ovens.

Detection of intracellular PCR products is generally achieved by one of two different techniques, indirect in situ PCR by ISH with PCR-product specific probes, or direct in situ PCR without ISH through direct detection of labeled nucleotides (such as digoxigenin-11-dUTP, fluorescein-dUTP, 3H-CTP or biotin-16-dUTP), which have been incorporated into the PCR products during thermal cycling.

### Arrays for Profiling Inflammatory Gene Expression

In particular embodiments provided herein, arrays can be used to evaluate inflammatory gene expression and/or microRNA expression, for example to prognose a colon adenocarcinoma. When describing an array that consists essentially of probes or primers specific for PRG1, IL-10, IL-12a, IL-17a, IL-23a, CD68, ANXA1, FOXP3, and HLA-DRA, such an array includes probes or primers specific for these nine inflammatory genes, and can further include control probes (for example to confirm the incubation conditions are sufficient), probes for 1-6 additional inflammatory genes, probes for miR-21, but not other probes. Exemplary control probes include GAPDH, actin, and YWHAZ. In one example, an array is a multi-well plate (e.g., 98 or 364 well plate).

In one example, the array includes, consists essentially of, or consists of probes or primers (such as an oligonucleotide or antibody) that can recognize PRG1, IL-10, IL-12a, IL-17a, IL-23a, CD68, ANXA1, FOXP3, and HLA-DRA. The oligonucleotide probes or primers can further include one or more detectable labels, to permit detection of hybridization signals between the probe and target sequence (such as one of the 9 inflammatory genes disclosed herein).

Array Substrates

The solid support of the array can be formed from an organic polymer. Suitable materials for the solid support include, but are not limited to: polypropylene, polyethylene, polybutylene, polyisobutylene, polybutadiene, polyisoprene, polyvinylpyrrolidine, polytetrafluoroethylene, polyvinylidene difluoroide, polyfluoroethylene-propylene, polyethylenevinyl alcohol, polymethylpentene, polycholorotrifluoroethylene, polysulformes, hydroxylated biaxially oriented polypropylene, aminated biaxially oriented polypropylene, thiolated biaxially oriented polypropylene, etyleneacrylic acid, thylene methacrylic acid, and blends of copolymers thereof (see U.S. Pat. No. 5,985,567).

In general, suitable characteristics of the material that can be used to form the solid support surface include: being amenable to surface activation such that upon activation, the surface of the support is capable of covalently attaching a biomolecule such as an oligonucleotide thereto; amenability to “in situ” synthesis of biomolecules; being chemically inert such that at the areas on the support not occupied by the oligonucleotides or proteins (such as antibodies) are not amenable to non-specific binding, or when non-specific binding occurs, such materials can be readily removed from the surface without removing the oligonucleotides or proteins (such as antibodies).

In one example, the solid support surface is polypropylene. Polypropylene is chemically inert and hydrophobic. Non-specific binding is generally avoidable, and detection sensitivity is improved. Polypropylene has good chemical resistance to a variety of organic acids (such as formic acid), organic agents (such as acetone or ethanol), bases (such as sodium hydroxide), salts (such as sodium chloride), oxidizing agents (such as peracetic acid), and mineral acids (such as hydrochloric acid). Polypropylene also provides a low fluorescence background, which minimizes background interference and increases the sensitivity of the signal of interest.

In another example, a surface activated organic polymer is used as the solid support surface. One example of a surface activated organic polymer is a polypropylene material aminated via radio frequency plasma discharge. Such materials are easily utilized for the attachment of nucleotide molecules. The amine groups on the activated organic polymers are reactive with nucleotide molecules such that the nucleotide molecules can be bound to the polymers. Other reactive groups can also be used, such as carboxylated, hydroxylated, thiolated, or active ester groups.

Array Formats

A wide variety of array formats can be employed in accordance with the present disclosure. One example includes a linear array of oligonucleotide bands, generally referred to in the art as a dipstick. Another suitable format includes a two-dimensional pattern of discrete cells (such as 4096 squares in a 64 by 64 array). As is appreciated by those skilled in the art, other array formats including, but not limited to slot (rectangular) and circular arrays are equally suitable for use (see U.S. Pat. No. 5,981,185). In some examples, the array is a multi-well plate. In one example, the array is formed on a polymer medium, which is a thread, membrane or film. An example of an organic polymer medium is a polypropylene sheet having a thickness on the order of about 1 mil. (0.001 inch) to about 20 mil., although the thickness of the film is not critical and can be varied over a fairly broad range. The array can include biaxially oriented polypropylene (BOPP) films, which in addition to their durability, exhibit low background fluorescence.

The array formats of the present disclosure can be included in a variety of different types of formats. A “format” includes any format to which the solid support can be affixed, such as microtiter plates (e.g. multi-well plates), test tubes, inorganic sheets, dipsticks, and the like. For example, when the solid support is a polypropylene thread, one or more polypropylene threads can be affixed to a plastic dipstick-type device; polypropylene membranes can be affixed to glass slides. The particular format is, in and of itself, unimportant. All that is necessary is that the solid support can be affixed thereto without affecting the functional behavior of the solid support or any biopolymer absorbed thereon, and that the format (such as the dipstick or slide) is stable to any materials into which the device is introduced (such as clinical samples and hybridization solutions).

The arrays of the present disclosure can be prepared by a variety of approaches. In one example, oligonucleotide or protein sequences are synthesized separately and then attached to a solid support (see U.S. Pat. No. 6,013,789). In another example, sequences are synthesized directly onto the support to provide the desired array (see U.S. Pat. No. 5,554,501). Suitable methods for covalently coupling oligonucleotides and proteins to a solid support and for directly synthesizing the oligonucleotides or proteins onto the support are known to those working in the field; a summary of suitable methods can be found in Matson et al., Anal. Biochem. 217:306-10, 1994. In one example, the oligonucleotides are synthesized onto the support using conventional chemical techniques for preparing oligonucleotides on solid supports (such as see PCT applications WO 85/01051 and WO 89/10977, or U.S. Pat. No. 5,554,501).

A suitable array can be produced using automated means to synthesize oligonucleotides in the cells of the array by laying down the precursors for the four bases in a predetermined pattern. Briefly, a multiple-channel automated chemical delivery system is employed to create oligonucleotide probe populations in parallel rows (corresponding in number to the number of channels in the delivery system) across the substrate. Following completion of oligonucleotide synthesis in a first direction, the substrate can then be rotated by 90° to permit synthesis to proceed within a second (2°) set of rows that are now perpendicular to the first set. This process creates a multiple-channel array whose intersection generates a plurality of discrete cells.

The oligonucleotides can be bound to the polypropylene support by either the 3′ end of the oligonucleotide or by the 5′ end of the oligonucleotide. In one example, the oligonucleotides are bound to the solid support by the 3′ end. However, one of skill in the art can determine whether the use of the 3′ end or the 5′ end of the oligonucleotide is suitable for bonding to the solid support. In general, the internal complementarity of an oligonucleotide probe in the region of the 3′ end and the 5′ end determines binding to the support.

In particular examples, the oligonucleotide probes on the array include one or more labels, that permit detection of oligonucleotide probe:target sequence hybridization complexes.

### Methods for Detection of Protein

In some examples, expression of PRG1, IL-10, IL-12a, IL-17a, IL-23a, CD68, ANXA1, FOXP3 and HLA-DRA proteins is analyzed. Suitable biological samples include samples containing protein obtained from a colon adenocarcinoma of a subject, noncancerous tissue from the subject, and protein obtained from one or more samples of cancer-free subject(s). An alteration in the amount of PRG1, IL-10, IL-12a, IL-17a, IL-23a, CD68, ANXA1, FOXP3, and HLA-DRA proteins in a colon adenocarcinoma and a non-cancerous sample from the subject, such as an increase or decrease in expression, indicates the prognosis of the subject, as described above.

The availability of antibodies specific to PRG1, IL-10, IL-12a, IL-17a, IL-23a, CD68, ANXA1, FOXP3, and HLA-DRA proteins facilitates the detection and quantitation of inflammatory proteins by one of a number of immunoassay methods that are well known in the art, such as those presented in Harlow and Lane (Antibodies, A Laboratory Manual, CSHL, New York, 1988). Methods of constructing such antibodies are known in the art. It should be noted that antibodies to all of these inflammatory proteins are available from several commercial sources.

Any standard immunoassay format (such as ELISA, Western blot, or RIA assay) can be used to measure protein levels. A comparison to tissue from an organ of a cancer-free subject can easily be performed. Thus, PRG1, IL-10, IL-12a, IL-17a, IL-23a, CD68, ANXA1, FOXP3, and HLA-DRA polypeptide levels in a colon adenocarcinoma or in noncancerous tissue from the same organ can readily be evaluated using these methods Immunohistochemical techniques can also be utilized for inflammatory gene detection and quantification. General guidance regarding such techniques can be found in Bancroft and Stevens (Theory and Practice of Histological Techniques, Churchill Livingstone, 1982) and Ausubel et al. (Current Protocols in Molecular Biology, John Wiley & Sons, New York, 1998).

For the purposes of quantitating inflammatory proteins, a biological sample of the subject that includes cellular proteins can be used. Quantitation of PRG1, IL-10, IL-12a, IL-17a, IL-23a, CD68, ANXA1, FOXP3, and HLA-DRA protein can be achieved by immunoassay. The amount PRG1, IL-10, IL-12a, IL-17a, IL-23a, CD68, ANXA1, FOXP3, and HLA-DRA protein can be assessed in both the colon adenocarcinoma and adjacent noncancerous tissue can be assessed, and in some examples also in tissue from cancer-free subjects. The amounts in the colon adenocarcinoma and the noncancerous tissue can be compared to levels of the protein found in cells from a cancer-free subject or other control (such as a standard value or reference value). A significant increase or decrease in the amount can be evaluated using statistical methods disclosed herein and/or known in the art.

Quantitative spectroscopic approaches methods, such as SELDI, can be used to analyze PRG1, IL-10, IL-12a, IL-17a, IL-23a, CD68, ANXA1, FOXP3, and HLA-DRA expression in a sample (such as non-cancerous tissue, tumor tissue, and tissue from a cancer-free subject). In one example, surface-enhanced laser desorption-ionization time-of-flight (SELDI-TOF) mass spectrometry is used to detect protein expression, for example by using the ProteinChip™ (Ciphergen Biosystems, Palo Alto, Calif.). Such methods are well known in the art (for example see U.S. Pat. No. 5,719,060; U.S. Pat. No. 6,897,072; and U.S. Pat. No. 6,881,586). SELDI is a solid phase method for desorption in which the analyte is presented to the energy stream on a surface that enhances analyte capture or desorption.

Briefly, one version of SELDI uses a chromatographic surface with a chemistry that selectively captures analytes of interest, such as inflammatory proteins. Chromatographic surfaces can be composed of hydrophobic, hydrophilic, ion exchange, immobilized metal, or other chemistries. For example, the surface chemistry can include binding functionalities based on oxygen-dependent, carbon-dependent, sulfur-dependent, and/or nitrogen-dependent means of covalent or noncovalent immobilization of analytes. The activated surfaces are used to covalently immobilize specific “bait” molecules such as antibodies, receptors, or oligonucleotides often used for biomolecular interaction studies such as protein-protein and protein-DNA interactions.

The surface chemistry allows the bound analytes to be retained and unbound materials to be washed away. Subsequently, analytes bound to the surface (such as inflammatory proteins) can be desorbed and analyzed by any of several means, for example using mass spectrometry. When the analyte is ionized in the process of desorption, such as in laser desorption/ionization mass spectrometry, the detector can be an ion detector. Mass spectrometers generally include means for determining the time-of-flight of desorbed ions. This information is converted to mass. However, one need not determine the mass of desorbed ions to resolve and detect them: the fact that ionized analytes strike the detector at different times provides detection and resolution of them. Alternatively, the analyte can be detectably labeled (for example with a fluorophore or radioactive isotope). In these cases, the detector can be a fluorescence or radioactivity detector. A plurality of detection means can be implemented in series to fully interrogate the analyte components and function associated with retained molecules at each location in the array.

Therefore, in a particular example, the chromatographic surface includes antibodies that specifically bind PRG1, IL-10, IL-12a, IL-17a, IL-23a, CD68, ANXA1, FOXP3, and HLA-DRA. In other examples, the chromatographic surface consists essentially of, or consists of, antibodies that specifically bind PRG1, IL-10, IL-12a, IL-17a, IL-23a, CD68, ANXA1, FOXP3, and HLA-DRA. In this context “consists essentially of” indicates that the chromatographic surface does not include antibodies that bind any other inflammatory proteins, but can include antibodies that bind other molecules, such as housekeeping proteins (e.g. actin or myosin).

In another example, antibodies are immobilized onto the surface using a bacterial Fc binding support. The chromatographic surface is incubated with a sample, such as a sample of a colon adenocarcinoma or non-cancerous tissue from the subject. The antigens present in the sample can recognize the antibodies on the chromatographic surface. The unbound proteins and mass spectrometric interfering compounds are washed away and the proteins that are retained on the chromatographic surface are analyzed and detected by SELDI-TOF. The MS profile from the sample can be then compared using differential protein expression mapping, whereby relative expression levels of proteins at specific molecular weights are compared by a variety of statistical techniques and bioinformatic software systems.

V. Methods for Detecting MicroRNA-21 (miR-21) Expression

MicroRNAs are noncoding RNA molecules with potential as biomarkers in cancer (Calin et al., N Engl J Med 353:1793-801, 2005; Johnson et al., Cell 120:635-47, 2005; Volinia et al., Proc Natl Acad Sci USA 103:2257-61, 2006; Yanaihara et al., Cancer Cell 9:189-98, 2006; Cummins et al., Proc Natl Acad Sci U S A 103:3687-92, 2006). In a previous study, it was determined that patients with tumors expressing high levels of microRNA-21 (miR-21), have worse survival prognosis for stage II or stage III colon adenocarcinoma (Schetter et al., JAMA 299:425-36, 2008; PCT Publication No. WO 2008/008430, herein incorporated by reference). Combining multiple prognostic biomarkers may improve the ability to identify high risk cancer patients compared to biomarkers with single biological endpoints. Thus, in some embodiments of the methods provided herein, inflammatory gene expression profiles are used in combination with the expression of miR-21 to predict prognosis of a patient diagnosed with colon adenocarcinoma.

The sequences of precursor microRNAs (pre-miRNAs) and mature miRNAs are publicly available, such as through the miRBase database, available online by the Sanger Institute (see Griffiths-Jones et al., Nucleic Acids Res. 36:D154-D158, 2008; Griffiths-Jones et al., Nucleic Acids Res. 34:D140-D144, 2006; and Griffiths-Jones, Nucleic Acids Res. 32:D109-D111, 2004). miR-21 sequences are publicly available, for example, GENBANK® Accession numbers AC004686 (deposited Oct. 14, 2006); BC053563.1 (deposited Jun. 10, 2003) AF480524.1 (deposited May 1, 2002); AJ421741.1 (Dec. 12, 2001); and AY699265.1 (deposited Dec. 21, 2004).

Detection and quantification of microRNA expression can be achieved by any one of a number of methods well known in the art (see, for example, U.S. Patent Application Publication Nos. 2006/0211000 and 2007/0299030, herein incorporated by reference). Using the known sequences for miR-21, specific probes and primers can be designed for use in the detection methods described herein as appropriate.

In some cases, the microRNA detection method includes isolation of nucleic acid from a sample, such as a cell or tissue sample. Nucleic acids, including RNA and specifically miRNA, can be isolated using any suitable technique known in the art. For example, phenol-based extraction is a common method for isolation of RNA. Phenol-based reagents contain a combination of denaturants and RNase inhibitors for cell and tissue disruption and subsequent separation of RNA from contaminants. Phenol-based isolation procedures can recover RNA species in the 10-200-nucleotide range (e.g., precursor and mature miRNAs, 5S and 5.8S ribosomal RNA (rRNA), and U1 small nuclear RNA (snRNA)). In addition, extraction procedures such as those using TRIZOL™ or TRI REAGENT™, will purify all RNAs, large and small, and are efficient methods for isolating total RNA from biological samples that contain miRNAs and small interfering RNAs (siRNAs).

Microarray analysis of microRNAs can be accomplished according to any method known in the art (see, for example, PCT Publication No. WO 2008/054828; Ye et al., Nat. Med. 9(4):416-423, 2003; Calin et al., N. Engl. J. Med. 353(17):1793-1801, 2005, each of which is herein incorporated by reference). In one example, RNA is extracted from a cell or tissue sample, the small RNAs (18-26-nucleotide RNAs) are size-selected from total RNA using denaturing polyacrylamide gel electrophoresis. Oligonucleotide linkers are attached to the 5′ and 3′ ends of the small RNAs and the resulting ligation products are used as templates for an RT-PCR reaction with 10 cycles of amplification. The sense strand PCR primer has a fluorophore attached to its 5′ end, thereby fluorescently labeling the sense strand of the PCR product. The PCR product is denatured and then hybridized to the microarray. A PCR product, referred to as the target nucleic acid that is complementary to the corresponding microRNA capture probe sequence on the array will hybridize, via base pairing, to the spot at which the capture probes are affixed. The spot will then fluoresce when excited using a microarray laser scanner. The fluorescence intensity of each spot is then evaluated in terms of the number of copies of a particular miRNA, using a number of positive and negative controls and array data normalization methods, which will result in assessment of the level of expression of a particular miRNA.

In an alternative method, total RNA containing the small RNA fraction (including the miRNA) extracted from a cell or tissue sample is used directly without size-selection of small RNAs, and 3′ end labeled using T4 RNA ligase and either a fluorescently-labeled short RNA linker. The RNA samples are labeled by incubation at 30° C. for 2 hours followed by heat inactivation of the T4 RNA ligase at 80° C. for 5 minutes. The fluorophore-labeled miRNAs complementary to the corresponding miRNA capture probe sequences on the array will hybridize, via base pairing, to the spot at which the capture probes are affixed. The microarray scanning and data processing is carried out as described above.

Any one of a number of methods for detecting expression of a gene of interest (including microRNAs) known in the art can be used to detect expression of miR-21. A number of these methods, including qRT-PCR, array, microarray, in situ hybridization, in situ PCR, SAGE are described herein in regard to detection of inflammatory gene expression.

VI. Tissue Samples

The methods provided herein include detecting expression of one or more inflammatory genes and/or miR-21 in colon adenocarcinoma and non-cancerous tissue samples. In some embodiments, the tissue samples are obtained from subjects diagnosed with colon adenocarcinoma and, in some cases, from healthy subjects or cadaveric donors. A “sample” refers to part of a tissue that is either the entire tissue, or a diseased or healthy portion of the tissue. As described herein, tumor tissue samples are compared to a control. In some embodiments, the control is non-cancerous tissue sample obtained from the same subject, such as non-cancerous colon tissue surrounding the tumor. In other embodiments, the control is a colon tissue sample obtained from a healthy patient or a non-cancerous tissue sample from a cadaver. In other embodiments, the reference sample is a standard or reference value based on an average of historical values.

Tissue samples can be obtained from a subject using any method known in the art. For example, tissue samples can be obtained from colon cancer patients who have undergone tumor resection as a form of treatment. From these patients, both tumor tissue and surrounding non-cancerous colon tissue can be obtained. In some embodiments, the non-cancerous tissue sample used as a control is obtained from a cadaver. In other embodiments, the non-cancerous tissue sample is obtained from a healthy liver donor (see Kim et al., Hepatology 39(2):518-527, 2004).

In some embodiments, tissue samples are obtained by biopsy. Biopsy samples can be fresh, frozen or fixed, such as formalin-fixed and paraffin embedded. Samples can be removed from a patient surgically, by extraction (for example by hypodermic or other types of needles), by microdissection, by laser capture, or by any other means known in the art.

The following examples are provided to illustrate certain particular features and/or embodiments. These examples should not be construed to limit the disclosure to the particular features or embodiments described.

### EXAMPLES

### Example 1

### Materials and Methods

### Tissue Collection and RNA Isolation

Pairs of primary colon tumor and adjacent noncancerous tissues came from 83 patients recruited from the University of Maryland Medical Center or Baltimore Veterans Administration Medical Center between 1993 and 2002, and from 113 patients recruited from Queen Mary Hospital in Hong Kong between 1991 and 2000 (Schetter et al., JAMA 299:425-36, 2008, herein incorporated by reference). Cases with familial adenomatous polyposis were excluded.

Tissues were flash frozen after surgery, prior to any adjuvant therapy. Detailed backgrounds for each tissue donor, including age, gender, clinical staging, tumor location and survival time from diagnosis were collected. Tumor histopathology was classified according to the World Health Organization Classification of Tumor system (Aaltonen & Hamilton, World Health Organization, International Agency for Research on Cancer, 2000).

### RNA Isolation and Quantitative RT-PCR of Inflammatory Genes

RNA from frozen tissue samples was extracted using standard TRIZOL™ (Invitrogen, Carlsbad, Calif.) methods. RNA was reverse transcribed using cDNA Archive Kit (Applied Biosystems, Foster City, Calif.) with a 50 ng/μl final concentration. Expression levels of inflammatory genes were measured with custom-designed, Taqman low-density-array real-time polymerase chain reaction (PCR) plates (Applied Biosystems, Foster City, Calif.) containing probes to 23 inflammatory genes (the sequences for each can be obtained from Applied Biosystems): Annexin A1 (ANXA1) (assay ID Hs00167549_m1), colon stimulating factor 1 (CSF1) (assay ID Hs00174164_m1), major histocompatibility complex (MHC) class II antigen DRα (HLA-DRA) (ID Hs00219575_m1), MHC class II antigen DPα1 (HLA-DPA1) (ID Hs00410276_m1), interferon γ (IFN-γ) (ID Hs00174143_m1), interleukin 1α (IL-1A) (ID Hs00174092_m1), interleukin 1β (IL-1B) (ID Hs00174097_m1), interleukin 2 (IL-2) (ID Hs00174114_m1), interleukin 4 (IL-4) (ID Hs00174122_m1), interleukin 5 (IL-5) (ID Hs00174200_m1), interleukin 6 (IL-6) (ID Hs00174131_m1), interleukin 8 (IL-8) (ID Hs00174103_m1), interleukin 10 (IL-10) (ID Hs00174086_m1), interleukin 12p35 (IL-12A) (ID Hs00168405_m1), interleukin 12p45 (IL-12B) (ID Hs00233688_m1), interleukin 15 (IL-15) (ID Hs00542571_m1), interleukin 17A (IL-17A) (ID Hs00174383_m1), interleukin 23 (IL-23A) (ID Hs00372324_m1), proteoglycan 1 (PRG1) (ID Hs00160444_m1), nitric oxide synthase 2A (NOS2A) (ID Hs00167257_m1), forkhead box p3 (FOXP3) (ID Hs00203958_m1), cluster of differentiation 68 (CD68) (ID Hs00154355_m1), and tumor necrosis factor α (TNF-α) (ID Hs00174128_m1) with 18s rRNA (ID Hs99999901_s1) as a normalization control. Expression of inflammatory genes was measured while blinded to all clinical outcomes. For quality control, any tissue that had 18s threshold cycle values greater than 15 were considered poor quality and were removed. A patient was removed from this study if either noncancerous or paired tumor tissues failed quality control.

Measurement of miR-21

microRNA expression levels were previously measured in all of the patient samples (Schetter et al., JAMA 299:425-36, 2008). Briefly, microRNA expression levels in the NCI-Maryland cohort were measured using microRNA microarrays (Ohio State microRNA microarray version 2.0). For the Hong Kong Cohort, expression of miR-21 was measured using quantitative RT-PCR using Taqman MicroRNA assays (Applied Biosystems, Foster City, Calif.) according to manufacturer's instructions. High expression cases for miR-21 were defined based on highest tertile separately for the microarrays and qRT-PCR results.

### Statistical Analyses

Expression data was imported into Biometric Research Branch Array Tools v3.6.0 (available online) and median normalized for the Hong Kong cohort and Maryland cohort separately. Paired t tests identified differentially expressed genes between tumor and noncancerous tissue for the Hong Kong and the Maryland cohort separately. To account for multiple comparisons, only differences that were found and validated in each cohort separately (P<0.05) were considered significant. Graphpad Prism v5.0 (Graphpad Software Inc.) was used for correlation analysis.

The Hong Kong cohort was divided randomly into a training and test cohort to identify a gene expression model associated with cancer-specific mortality. The Maryland cohort was used as the validation cohort for this model. Prior to beginning the analysis, the Hong Kong cohort was selected to divide into the training and test cohort since it was the larger of the two cohorts and likely result in a model with improved accuracy compared to the smaller, Maryland cohort.

Univariate Cox regression analysis on the training cohort was used to select genes associated with cancer-specific mortality (|Z-score|>1.5; p<0.13) to include in multivariate risk models using previously reported methods (Lossos et al., N Engl J Med 350:1828-37, 2004). All genes were included for these purposes and expression values for all analyses are continuous variables.

For multivariate Cox regression models, missing values for genes were replaced with the average values. In the training cohort, selected genes were used to build multivariate models for tumor and noncancerous tissue separately. Coefficients from these models were multiplied with gene expression values and summed to build risk scores. Individuals were defined as high risk if they had higher than median risk scores for both tumor and noncancerous models. Neither the noncancerous risk score nor the tumor risk score were significantly associated with cancer-specific mortality in the Hong Kong test cohort individually, but were significantly associated when combined. This method was validated in the NCI-Maryland validation cohort. Kaplan Meier analysis was performed with WINSTAT 2007 (R Fitch Software). Cox regression was performed in Stata 9.2 (StataCorp LP, College Station, Tex.).

Linear regression models identified associations between miR-21 expression and inflammatory gene expression in noncancerous tissue, tumor tissue and then a combined analysis of both tumor and noncancerous tissue adjusting for tumor status. Only the qRT-PCR data from the Hong Kong cohort was analyzed for these purposes since the microarray data from the Maryland cohort was considered less reliable. IL-4, IL-5, and IL-12b were excluded since they were missing data for >25% of the samples. The Bonferroni-Holm method (Holm, Scandinavian Journal of Statistics 6:65-70, 1979) was used to adjust for multiple comparisons in the combined tumor and noncancerous regression models.

### Example 2

### Expression of Inflammatory Genes are Systematically Altered in Colon Adenocarcinoma

This study used two independent cohorts, one consisting of 113 cases recruited from Hong Kong and a second cohort of 83 cases recruited from Maryland (Table 1).

TABLE 1
Characteristics of Study Populations and Tumors

| | Hong Kong Cohort | | Maryland Cohort |
|---|---|---|---|
| | Training (n = 57) | Test (n = 56) | Validation (n = 83) |
| Age (years) at enrollment | | | |
| Mean (SD) | 57.8 (15.5) | 53.8 (14.1) | 64.4 (10.6) |
| Range | 32-84 | 30-82 | 32-87 |
| Gender, No (%) | | | |
| Male | 30 (53) | 26 (46) | 65 (78) |
| Female | 27 (47) | 30 (54) | 18 (22) |
| Tumor location^{a}, No. (%) | | | |
| Distal | 41 (72) | 49 (87.5) | 48 (59) |
| Proximal | 16 (28) | 7 (12.5) | 33 (41) |
| Adenocarcinoma Histology, No. (%) | | | |
| Adenocarcinoma | 53 (93) | 52 (93) | 74 (89) |
| Mucinous Adenocarcinoma | 4 (7) | 3 (5) | 8 (10) |
| Adenosquamous | 0 (0) | 0 (0) | 1 (1) |
| Signet Ring Cell and Mucinous | 0 (0) | 1 (2) | 0 (0) |
| TNM staging^{b}, No. (%) | | | |
| I | 2 (4) | 7 (13) | 8 (10) |
| II | 19 (33) | 18 (32) | 29 (35) |
| III | 27 (47) | 21 (38) | 36 (43) |
| IV | 9 (16) | 10 (18) | 9 (11) |
| Removed during quality control^{c} | 0 (0) | 0 (0) | 10 (12) |

^{a}Distal includes tumors located in or distal to the descending colon. Proximal tumors include tumors in or proximal to the splenic flexure. Tumor location was available for all cases of the Hong Kong Cohort and 81 cases in the Maryland Cohort.
^{b}For 1 patient in the Maryland Cohort, it was unclear if that patient had stage III or stage IV colon cancer, therefore this patient was removed from analyses stratifying by TNM stage.
^{c}Cases with poor quality data from quantitative RT-PCR for either the tumor or nontumorous tissue were removed.

The median follow-up time was months 84.6 and 80.0 months for patients in Hong Kong cohort or NCI-Maryland cohort, respectively. The cohorts were similar in TNM staging (p=0.65, Fisher's exact) and cancer-specific mortality (p=0.46; Kaplan Meier log rank) with 5 year survival rates of 49.5% (Hong Kong Cohort) and 59.7% (NCI-Maryland Cohort).

Expression of 23 inflammatory genes in primary colon tumor and paired noncancerous tissues were measured using low-density-array real-time polymerase-chain reaction. IL-4 and IL-5 were not detectable in the majority of tissues and were removed from all further analyses.

Inflammatory gene expression was systematically altered in tumors. Expression of the 21 inflammatory genes could distinguish tumor from noncancerous tissue pairs with 99 or 100% accuracy based on nearest centroid or 3-nearest neighbors class prediction algorithms, respectively (10-fold cross validation repeated 100 times) using the Hong Kong cohort.

Unsupervised hierarchical clustering (correlation, average linkage) of the 21 genes separated tissues into two distinct groups; one composed of 97% tumor tissue and one composed of 99% non-tumorous tissue. Expression of 18 genes were altered in tumors in the Hong Kong Cohort (p<0.05; paired t-test) (Table 2). Of these, IL-8 demonstrated the largest fold-increase in tumors at ˜13-fold higher levels in tumors while IL-2 demonstrated the largest reduction in tumor with ˜80% less in tumors.

TABLE 2
Inflammatory genes that are differentially expressed in tumors
vs. non-cancerous tissue, by cohort or colon adenomas

| | | | NCI-Maryland | | | |
|---|---|---|---|---|---|---|
| | Hong Kong Cohort | | Cohort | | Adenoma Study | |
| | Fold | | Fold | | Fold | |
| | Change¹ | P-value² | Change¹ | P-value² | Change¹ | P-value² |
| Genes | | | | | | |
| Decreased | | | | | | |
| in Tumors | | | | | | |
| IL-2 | 0.23 | P < 1 × 10⁻⁷ | 0.30 | P < 1 × 10⁻⁷ | 0.54 | P = 0.007 |
| IL-15 | 0.42 | P < 1 × 10⁻⁷ | 0.67 | P = 0.006 | 0.79 | P = 0.27 |
| IL-10 | 0.46 | P < 1 × 10⁻⁷ | 0.74 | P = 0.006 | 0.61 | P = 0.09 |
| IL-12A | 0.58 | P = 1 × 10⁻⁷ | 0.57 | P = 3 × 10⁻⁷ | 0.62 | P = 0.009 |
| CSF1 | 0.58 | P < 1 × 10⁻⁷ | 0.54 | P = 2 × 10⁻⁶ | 0.61 | P = 0.01 |
| HLA- | 0.67 | P < 1 × 10⁻⁷ | 0.69 | P = 7 × 10⁻⁵ | 0.61 | P = 0.003 |
| DPA1 | | | | | | |
| HLA-DRA | 0.69 | P < 1 × 10⁻⁷ | 0.84 | P = 0.03 | 0.75 | P = 0.04 |
| PRG1 | 0.80 | P = 3 × 10⁻⁷ | 1.09 | P = 0.19 | 0.69 | P = 0.02 |
| TNF-a | 0.83 | P = 0.03 | 0.59 | P = 1 × 10⁻⁶ | 0.92 | P = 0.60 |
| CD68 | 0.90 | P = 0.02 | 0.76 | P = 0.0005 | 0.85 | P = 0.25 |
| Genes | | | | | | |
| Increased | | | | | | |
| in Tumors | | | | | | |
| IL-6 | 2.06 | P = 8 × 10⁻⁶ | 2.41 | P = 0.0001 | 1.50 | P = 0.44 |
| IFN-γ | 2.37 | P < 1 × 10⁻⁷ | 1.87 | P = 0.005 | 1.14 | P = 0.53 |
| IL-17A | 2.71 | P < 1 × 10⁻⁷ | 2.22 | P = 0.02 | 4.36 | P = 0.01 |
| FOXP3 | 3.33 | P < 1 × 10⁻⁷ | 1.65 | P = 0.0003 | 1.60 | P = 0.04 |
| IL-1B | 3.36 | P < 1 × 10⁻⁷ | 1.88 | P = 1 × 10⁻⁵ | 2.00 | P = 0.001 |
| IL-1A | 5.21 | P < 1 × 10⁻⁷ | 3.40 | P < 1 × 10⁻⁷ | 6.20 | P = 2.7 × 10⁻⁵ |
| IL-23A | 7.90 | P < 1 × 10⁻⁷ | 4.37 | P < 1 × 10⁻⁷ | 6.47 | P = 3.7 × 10⁻⁴ |
| IL-8 | 13.12 | P < 1 × 10⁻⁷ | 11.09 | P < 1 × 10⁻⁷ | 7.93 | P = 9.0 × 10⁻⁷ |

¹Fold change in tumors vs. non-cancerous tissues or adenoma vs. nonadenoma tissue where appropriate.
²Paired T-test. Genes included in this table were differentially expressed (P < 0.01) in at least one cohort and are organized from low to high based on fold change in the Hong Kong Cohort. Patient samples used included all that passed qRT-PCR quality control (n = 113 for Hong Kong Cohort, n = 73 for NCI-Maryland Cohort and n = 18 for adenoma study)

These results indicate a systematic change in the expression of inflammatory genes during tumorigenesis.

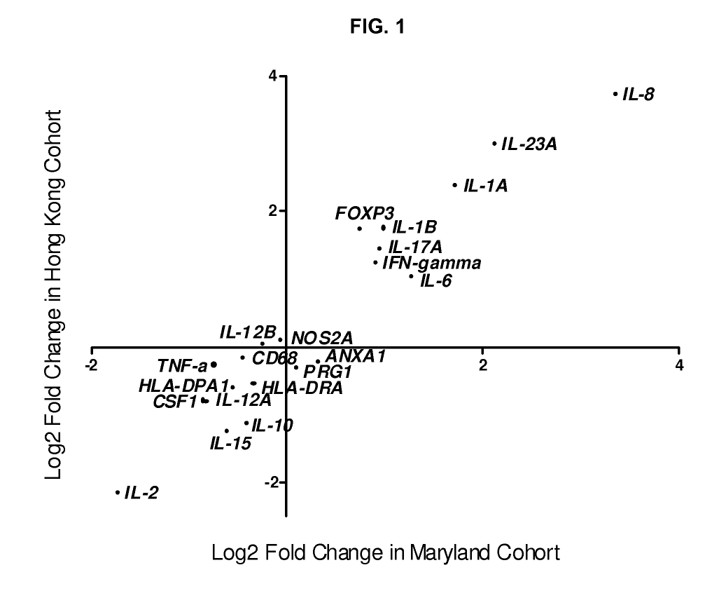

Next, the NCI-Maryland cohort was analyzed. Fold changes in tumors for these inflammatory genes were consistent with the Hong Kong cohort (Pearson R=0.96; FIG. 1) indicating that these changes in gene expression are likely representative of the majority of colon adenocarcinomas. Expression of IL-8, IL-23a, IL-1a, IL-1b, FOXP3 IL-17a, IFN-γ and IL-6 were significantly increased in tumors from both cohorts, while IL-2, IL-15, IL-10, IL-12a, CSF1, HLA-DPA1, HLA-DRA, TNF-a, and CD68 were significantly decreased in tumors from both cohorts.

Colon adenomas represent an early, precancerous lesion of the colon. Changes in inflammatory gene expression in adenoma tissues may indicate early changes in the inflammatory state that can lead to cancer. The expression levels of the 23 inflammatory-related genes were evaluated in 18 pairs of colon adenomas and non-adenoma tissues. While there was limited power to detect differences in expression of these genes due to using a limited number of tissues, similar changes in genes expression in adenoma as compared to the colon cancer tissues were observed (Table 2). When using the Hong Kong cohort as a reference, expression changes in colon adenomas were consistent with colon cancer tissues for these inflammatory genes (Pearson R=0.91; p<0.0001). Of the 10 genes significantly decreased in tumors, all showed decreased expression in adenomas and seven of these (IL-2, IL-10, IL-12a, CSF1, HLA-DPA1, HLA-DRA, and PRG1) were significantly reduced. Of the 8 genes significantly increased in tumors, all 8 were increased in adenomas and 6 of these (IL-8, IL-23a, IL-1a, IL-1b, FOXP3, and IL-17a) were significantly increased. Similar to colon cancer tissues, IL-8 showed the greatest increase and IL-2 showed the greatest decrease in adenoma tissues.

### Example 3

### Inflammatory Risk Score and Cancer-Specific Mortality

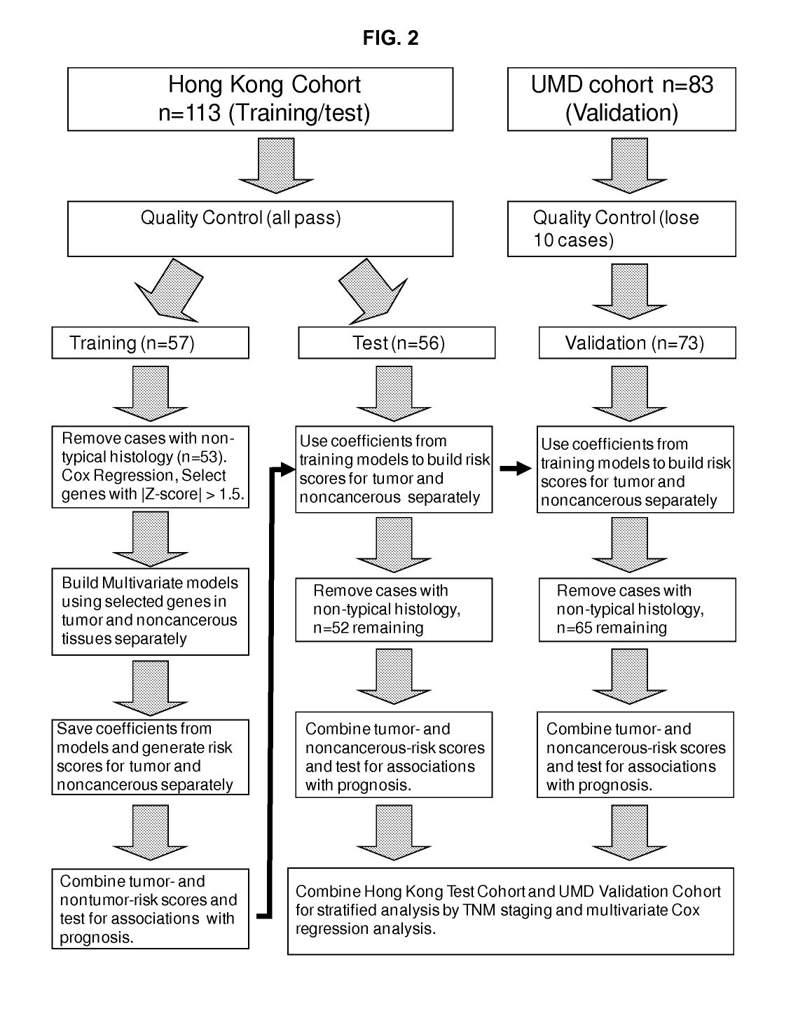

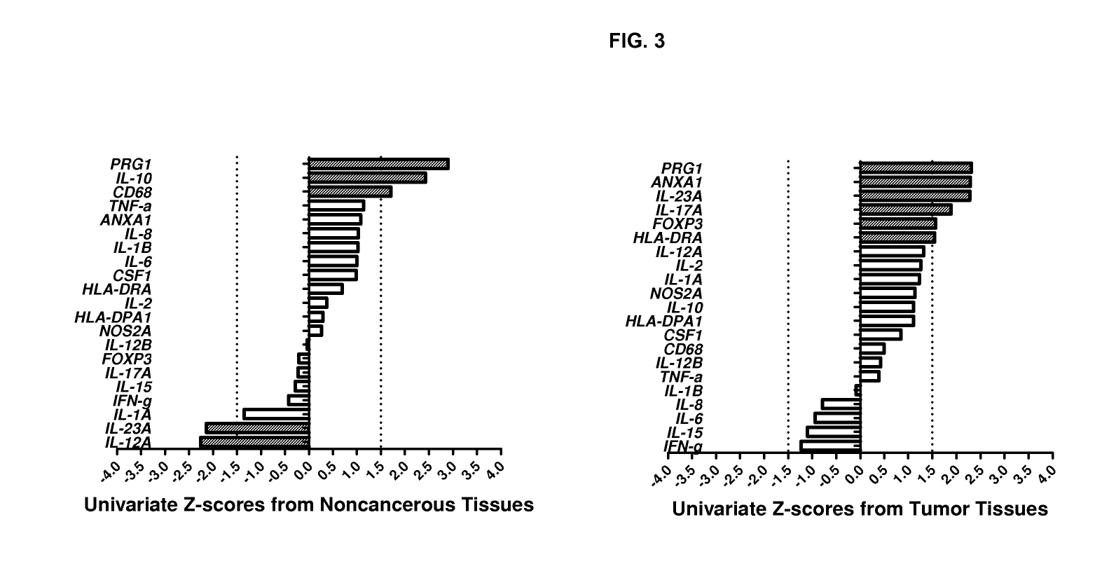

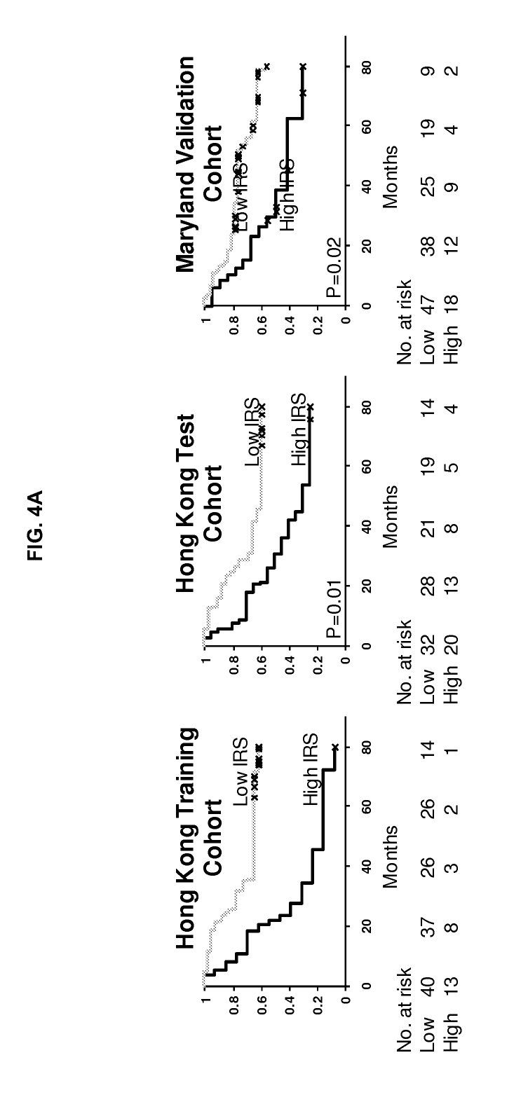

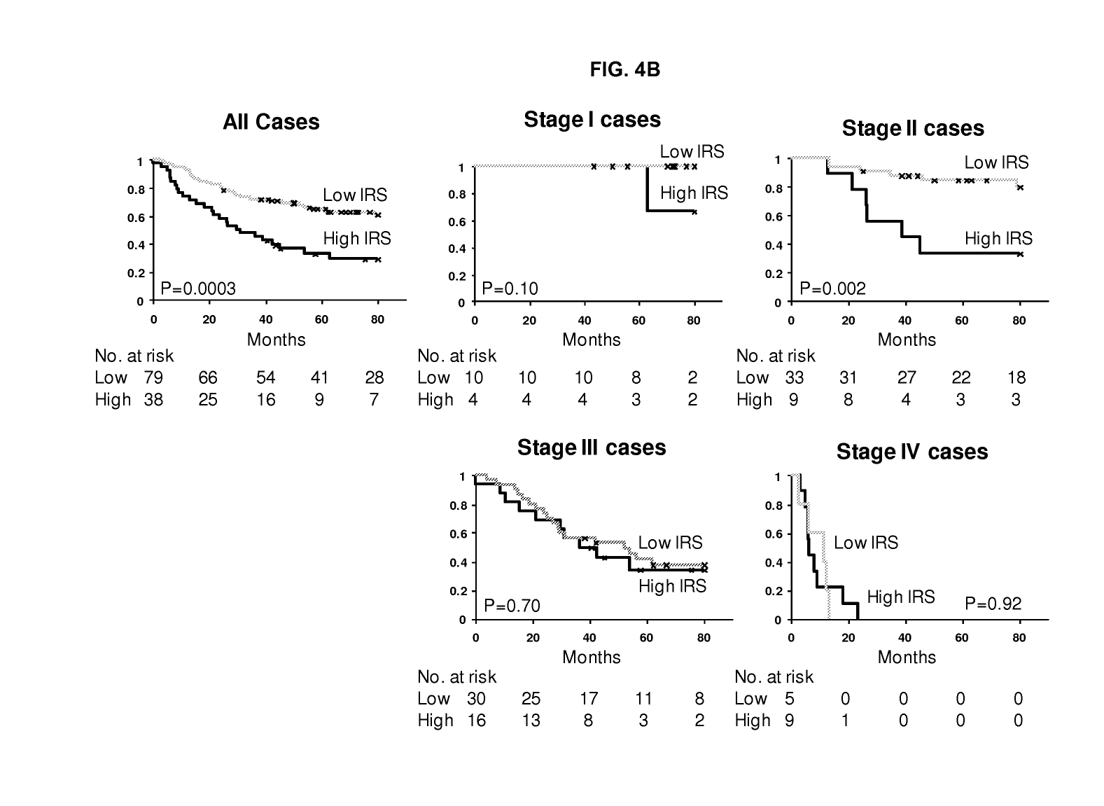

The expression of the inflammatory genes listed above in tumors and noncancerous tissue was evaluated for association with cancer-specific mortality. Constructing multi-gene signatures using several genes with moderate associations can provide more accurate predictions than single genes alone. Therefore, univariate Cox regression was used to identify genes with moderate associations with prognosis following previously established methodologies (Lossos et al., N Engl J Med 350:1828-37, 2004, herein incorporated by reference). The Hong Kong cohort was randomly split into a training cohort (n=57) and a test cohort (n=56) (FIG. 2). These cohorts were similar in clinical characteristics including age at enrollment, gender and TNM staging. Based on univariate Cox regression on the training cohort, expression of PRG1, IL-10, CD68, IL-23a and IL-12a in noncancerous tissue and PRG1, ANXA1, IL-23a, IL-17a, FOXP3 and HLA-DRA in tumors were moderately associated with cancer-specific mortality (|Z-score|>1.5) (FIG. 3). These genes were selected to construct a multi-gene risk signature. Using the training cohort, multivariate Cox regression was performed on selected genes to develop risk models. The noncancerous risk model was [(0.855*PRG1)+(0.720*IL-10)+(0.458*CD68)+(−0.494*IL-23a)+(−0.635*IL-12a)]=risk score. The tumor risk model was [(1.321*PRG1)+(0.840*ANXA1)+(0.123*IL-23a)+(0.484*IL-17a)+(0.367*FOXP3)+(−0.373*HLA-DRA)]=risk score. FIG. 3 was used to select the genes that were used for the combined model (those genes that show a correlation with prognosis by themselves). A positive coefficient indicates high levels are associated with poor survival (e.g., PRG1, IL-10, CD68 for noncancerous tissue). A negative value indicates that low expression levels are associated with poor prognosis (e.g., IL-23a, IL12a in noncancerous tissue). Individuals having higher than median values for both models were classified as having high inflammatory risk score (IRS). All others were considered low. When evaluated separately, patients classified as high IRS had significantly worse cancer-specific mortality for the Hong Kong training cohort, the Hong Kong test cohort (p=0.01, Kaplan Meier log rank) and NCI-Maryland validation cohort (p=0.02, Kaplan Meier log rank) (FIG. 4A).

### Example 4

### Inflammatory Risk Score Stratified by TNM Stage

To evaluate the potential use for IRS as a biomarker, a stratified analysis by TNM staging was performed. For these analyses, the Hong Kong training cohort was excluded to prevent over fitting the model. The Hong Kong test and NCI-Maryland validation cohorts were combined. IRS was associated with TNM stage (p=0.03, Fisher's exact test). Patients with more advanced TNM stage were more likely to be classified as high IRS. Four of 14 (29%) stage I, 9 of 42 (21%) stage II, 16 of 46 (35%) stage III, and 9 of 14 (64%) stage IV cases were classified as high IRS. High IRS was associated with poor cancer-specific mortality for all patients (p=0.0003, log rank) (FIG. 4B). IRS was associated with cancer-specific mortality in stage II cases (p=0.002, Kaplan Meier log rank) (FIG. 4B). IRS was not associated with prognosis in stage I, stage III, or stage IV patients.

### Example 5

### miR-21 Expression is Associated With Expression of IL-6, IL-8, IL-10, IL-12a and NOS2a

Expression of miR-21 was available for these samples from a previous study (Schetter et al., JAMA 299:425-36, 2008). Linear regression was used to examine the associations of miR-21 expression with inflammatory genes in these tissues. This was evaluated in noncancerous tissues, tumor tissues, and then a combination of all tissues adjusting for tumor status (Table 3).

TABLE 3
Association of miR-21 expression with IL-6, IL-12a, IL-8, IL-10, and NOS2a

| | Nontumor Tissue (n = 113) | | Tumor Tissue (n = 113) | | Combined (n = 226) | |
|---|---|---|---|---|---|---|
| | Regression | | Regression | | Regression | |
| | Coefficent | p-value | Coefficent | p-value | Coefficent | p-value |
| IL-6 | 0.13 | 0.004 | 0.13 | 0.01 | 0.13 | <0.0005 * |
| IL-12a | −0.26 | 0.018 | −0.19 | <0.0005 | −0.21 | <0.0005 * |
| IL-8 | 0.21 | <0.0005 | 0.05 | 0.209 | 0.13 | <0.0005 * |
| IL-10 | 0.32 | 0.012 | 0.14 | 0.053 | 0.21 | 0.002 * |
| NOS2a | −0.30 | 0.001 | −0.06 | 0.105 | −0.12 | 0.003 * |
| IL-1b | 0.29 | 0.001 | 0.02 | 0.616 | 0.12 | 0.006 |
| IL-17a | −0.04 | 0.645 | −0.12 | 0.001 | −0.10 | 0.012 |
| PRG1 | 0.39 | 0.040 | 0.15 | 0.207 | 0.26 | 0.019 |
| ANXA1 | 0.05 | 0.742 | 0.20 | 0.012 | 0.15 | 0.063 |
| IL2 | −0.21 | 0.050 | −0.04 | 0.509 | −0.11 | 0.065 |
| CD68 | −0.22 | 0.187 | 0.11 | 0.385 | −0.27 | 0.140 |
| CSF1 | −0.33 | 0.043 | 0.11 | 0.359 | −0.12 | 0.241 |
| TNF | 0.51 | 0.489 | 0.12 | 0.273 | 0.06 | 0.264 |
| IL23a | −0.21 | 0.071 | 0.00 | 0.960 | −0.05 | 0.315 |
| IFNG | 0.02 | 0.817 | −0.09 | 0.090 | −0.05 | 0.331 |
| HLADRA | −0.41 | 0.043 | 0.12 | 0.300 | −0.09 | 0.408 |
| IL1a | 0.07 | 0.435 | 0.00 | 0.934 | 0.02 | 0.651 |
| IL15 | 0.11 | 0.401 | −0.01 | 0.877 | 0.03 | 0.653 |
| FOXP3 | −0.02 | 0.850 | −0.02 | 0.808 | −0.02 | 0.768 |
| HLADPA1 | −0.10 | 0.563 | 0.11 | 0.354 | 0.00 | 0.985 |

* = statistically significant with Holm-Bonferonni method of adjustment for multiple comparisons. Coeffiencients are shown for linear regression models of miR-21 expression in nontumor tissue and tumor tissue separately with the expression of inflammatory genes. Combined models include both nontumor and tumor tissue and are adjusted for tumor status. Only the combined models are evaluated for significance.

In the combined model, expression of IL-6 (p<0.0005), IL-8 (p<0.0005) and IL-10 (p=0.002) were positively associated and IL-12a (p<0.0005) and NOS2a (p=0.0025) were negatively associated with miR-21 expression. Only IL-6 and IL-12a expression was statistically significant (p<0.05) in both the tumor and noncancerous tissues, separately.

### Example 6

### Combination of IRS and miR-21 Expression

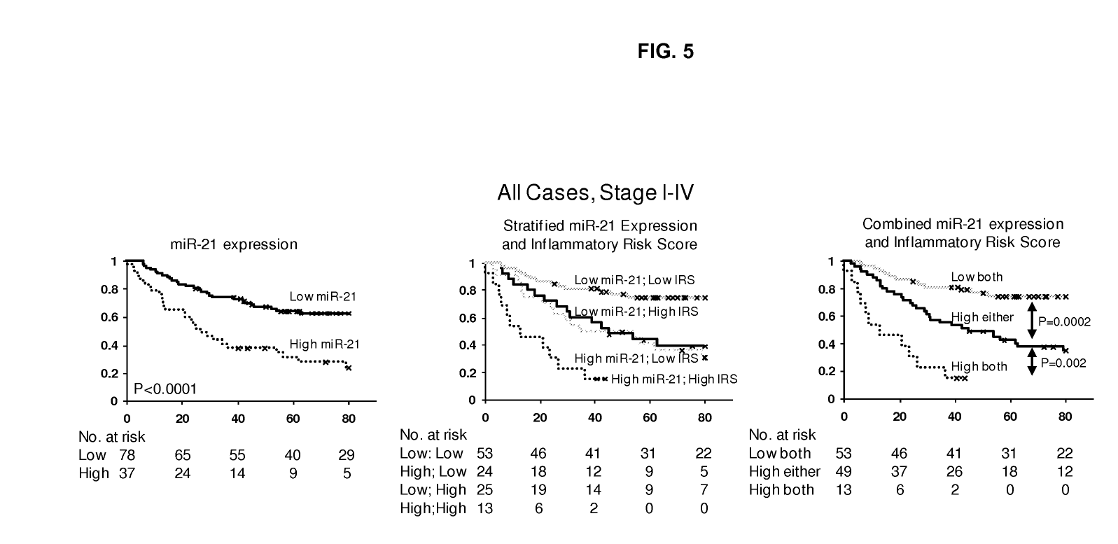

It was previously reported that high miR-21 expression in tumors was associated with poor prognosis in colon adenocarcinoma patients (Schetter et al., JAMA 299:425-36, 2008; PCT Publication No. WO 2008/008430, both herein incorporated by reference). That study utilized the same patients as the current study and provided a unique opportunity to combine miR-21 and IRS to determine if together they have improved prognostic utility. High miR-21 expression was defined in the previous publication where the highest tertile (>3.3-fold higher than average noncancerous tissue) is defined as high (Schetter et al., JAMA 299:425-36, 2008). Survival information for the NCI-Maryland cohort was updated from the previous study to include an additional 12 months. Consistent with the previous report (Schetter et al., JAMA 299:425-36, 2008), high miR-21 expression was associated with cancer-specific mortality using all cases (p<0.0001, Kaplan Meier log rank) or stage II cases (p=0.006, Kaplan Meier log rank) (FIG. 5).

While IRS and miR-21 expression were each associated with prognosis, they were not associated with one another (p=0.83, Fisher's exact). Therefore, combination of these biomarkers may identify high risk patients that would be misclassified by a single endpoint. A stratified analysis of miR-21 and IRS (FIG. 4) was performed. Patients with low miR-21 expression and low IRS had the best prognosis. Patients with high miR-21/low IRS or low miR-21/high IRS had an intermediate prognosis. Patients with high miR-21/high IRS had the worst prognosis. This was true when observing all cases or stage II cases alone. Upon combining intermediate groups, patients classified as high for either miR-21 or IRS score had significantly worse cancer-specific mortality than those classified as low miR-21/low IRS for all cases (p=0.0002, Kaplan Meier log rank) or stage II cases (p=0.002, Kaplan Meier log rank). Patients classified as high for both miR-21 and IRS had worse survival than patients classified as high for either using all cases (p=0.002, Kaplan Meier log rank) or stage II alone (p=0.02, Kaplan Meier log rank).

Univariate Cox regression analysis for all cases found high IRS (Hazard Ratio [HR]=2.4; 95% Confidence Interval [CI]=1.4-4.2), high miR-21 (HR=3.0; 95% CI=1.7-5.1) and TNM staging (HR=4.7; 95% CI=2.5-8.8) were each associated with poor prognosis (Table 4).

TABLE 4
Cox regression of Inflammatory Risk Score (IRS) and miR-21
expression with cancer-specific mortality on combined
Hong Kong test cohort and Maryland Validation cohort

| | Univariate analysis^{a} | | Multivariate analysis^{b} | |
|---|---|---|---|---|
| Variable (comparison/referent) | HR (95% CI) | P-value | HR (95% CI) | P-value |

All cases, regardless of TNM stage

| | | | | |
|---|---|---|---|---|
| IRS (high/low) | 2.4 (1.4-4.2) | 0.001 | 2.2 (1.3-3.8) | 0.005 |
| miR-21 expression (High/low) | 3.0 (1.7-5.1) | <0.0005 | 3.0 (1.7-5.2) | <0.0005 |
| Tumor Stage (III-IV/I-II) | 4.7 (2.5-8.8) | <0.0005 | 4.0 (2.1-7.5) | <0.0005 |
| Age (≧50/<50) | 1.1 (0.6-2.1) | 0.82 | | |
| Gender (male/female) | 1.9 (1.0-3.5) | 0.06 | | |
| Tumor Location (Proximal/ | 0.8 - (0.4-1.7) | 0.58 | | |
| Distal) | | | | |

Stage II cases, adjusted for cohort membership

| | | | | |
|---|---|---|---|---|
| IRS (high/low) | 5.4 (1.7-17.2) | 0.005 | 7.5 (2.2-25.6) | 0.001 |
| miR-21 expression (High/low) | 4.8 (1.4-16.1) | 0.01 | 6.5 (1.9-21.9) | 0.002 |
| Age (≧50/<50) | 2.9 (0.4-24.2) | 0.31 | | |
| Gender (male/female) | 1.4 (0.4-4.7) | 0.57 | | |
| Tumor Location (Proximal/ | 0.4 (0.1-1.7) | 0.20 | | |
| Distal) | | | | |

^{a}Univariate analysis is adjusted for cohort membership only.
^{b}Multivariate analysis is adjusted for IRS, miR-21 expression and (where appropriate) TNM stage. Multivariate analysis used stepwise addition and removal of clinical covariates found to be associated with survival in univariate models (P < 0.10) and final models include only those covariates that were significantly associated with survival (Wald statistic, P < 0.05). HR = Hazard Ratio. miR-21 measurements were available for 115 patients, including all 42 stage II patients, and only those patients are included in multivariate analyses.

Multivariate analyses demonstrated that both high IRS(HR=2.2, 95% CI=1.3 to 3.8) and high miR-21 (HR=3.0, 95% CI=1.7 to 5.2) were independent of one another and TNM staging. Additionally, the multivariate model including IRS, TNM staging and miR-21 performed significantly better than the model without miR-21 (p<0.001; likelihood ratio test). When restricting the analysis to stage 11 cases, univariate analyses demonstrated high IRS (HR=5.4; 95% CI=1.7-17.2) and high miR-21 (HR=4.8; 95% CI=1.4-16.1) were each associated with poor prognosis. Multivariate analysis demonstrated that high IRS (HR=7.5; 95% CI=2.2-25.6) and high miR-21 (HR=6.5; 95% CI=1.9-21.9) were each associated with prognosis independent of one another. A multivariate model including both IRS and miR-21 using stage II patients performed significantly better than a model including only IRS (p=0.004; likelihood ratio test). Therefore, IRS and miR-21 expression may be used together as a prognostic biomarker for stage II colon adenocarcinoma.

In summary, expression of inflammatory genes was associated with miR-21 expression in colon adenocarcinoma. The association of IL-6 and IL-12a expression was statistically significant in both the tumor and noncancerous tissues, separately. IL-6 may drive the expression of miR-21 in a STAT3 dependent mechanism (Loffler et al., Blood 110:1330-3, 2007). The results presented herein are consistent with that model and provide evidence that this mechanism can be relevant to colon cancer. There is a predicted binding site for miR-21 in the 3′ untranslated region of IL-12a as indicated by Targetscan 5.0 (Friedman et al., Genome Res 19:92-105, 2009) and miRanda (Betel et al., Nucleic Acids Res 36:D149-53, 2008). IL-12a has a negative correlation with miR-21, which is consistent with a pattern for a miR-21 target. Thus, the interaction between miR-21 and inflammatory genes may play a role in colon carcinogenesis.

The expression of inflammatory genes is altered in colon adenocarcinoma. Expression of inflammatory genes in tumors and the surrounding noncancerous tissues are associated with prognosis in colon adenocarcinoma. Higher expression of IL-10 in noncancerous tissues was associated with worse survival. IL-10 is an anti-inflammatory cytokine that can suppress cell-mediated immunity (O'Garra et al., Immunol Rev 223:114-31, 2008). Therefore, elevated IL-10 in noncancerous tissue may create an inflammatory environment primed for metastasis and disease progression.

High levels of IL-23a and IL-12a in the noncancerous tissue were associated with improved survival. Both are members of the IL-12 family of proinflammatory cytokines (Oppmann et al., Immunity 13:715-25, 2000). IL-12 activity is important for host resistance to tumors (Trinchieri, Nat Rev Immunol 3:133-46, 2003), therefore high levels of IL-12 in the tumor macroenvironment may lead to resistance of tumor progression and metastasis through induction of IFN-γ and activation of Natural Killer cells and cytotoxic T cells. In contrast, elevated IL-23a and IL-17a in cancerous tissues were associated with worse survival and may promote a microenvironment that suppresses any host anti-tumor response. IL-23a can stimulate Th17 cells to increase the production of IL-17a and overexpression of IL-17a in cervical cancer (Tartour et al., Cancer Res 59:3698-704, 1999), non-small cell lung cancer (Numasaki et al., J Immunol 175:6177-89, 2005), or fibrosarcoma (Numasaki et al., Blood 101:2620-7, 2003) cell lines increases tumor formation and/or tumor growth in xenograft mouse models. These cytokines are associated with a Th17 response. Therefore, a Th17 response in tumors may create a favorable condition for tumor progression.

Cancer immunotherapy is a promising field of research for colon cancer (Weiner, N Engl J Med 358:2664-5, 2008). As in any therapy, successful stratification of patients into groups that are more or less likely to respond will increase the chances of developing successful immunotherapies. IRS is based on the expression of inflammatory genes and the expression of these genes is likely to be correlated with the current state of the immune system. Thus IRS can be used to determine a patient's likely response to immunotherapy.

There is a need for better ways of diagnosing early stage colon cancer patients with undetectable micrometastases. A subset of stage II patients will benefit from therapeutic intervention as their disease will likely progress; but for others, therapeutic intervention unnecessarily harms quality of life and continued screening would be sufficient. Thus, IRS and miR-21, alone or in combination, can be used to determine the prognosis of stage II patients and assist in choosing treatment options.

### Example 7

### Use of Gene Expression Signatures to Classify a Patient as High or Low Risk

This example describes an exemplary method for determining whether a patient diagnosed with colon adenocarcinoma is a high risk patient or a low risk patient. The method involves the use of an inflammatory gene expression signature for the colon adenocarcinoma tissue, and in some cases, a separate signature for the adjacent non-cancerous tissue.

Expression of PRG1, ANXA1, IL-17a, IL-23a, and FOXP3 (and in some examples also HLA-DRA) is determined in the cancerous sample, and PRG1, IL-10, CD68, IL-12a and IL-23a determined in an adjacent non-cancerous sample obtained from a subject with stage II colon adenocarcinoma. Expression of these inflammatory genes can also be evaluated in adjacent non-cancerous tissue obtained from the subject. The samples are obtained during tumor biopsy or surgical resection of the tumor. RNA is isolated from the samples using a commercial kit or other method well known in the art, and subjected to quantitative real time RT-PCR to quantitate expression of the nine inflammatory genes.

The inflammatory gene expression signature for the colon adenocarcinoma tissue is compared with a reference inflammatory gene expression signature, such as a signature that represents average values in healthy control colon tissue. In some cases, the inflammatory gene expression signature of the non-cancerous tissue is also obtained and compared to an appropriate control (such as a signature obtained from a patient that does not have colon cancer).

Upon evaluation of the colon adenocarcinoma gene expression signature, if the sample exhibits an increase in expression of PRG1, ANXA1, IL-17a, IL-23a FOXP3 and HLA-DRA in the colon adenocarcinoma relative to the control gene expression signature, the patient is considered high risk. To further validate a patient's risk status, the gene expression signature of the adjacent non-cancerous tissue can also be evaluated. An increase in expression of PRG1, IL-10 and CD68 and a decrease in expression of IL-12a and IL-23a in the adjacent non-cancerous tissue relative to the control gene expression signature, further supports the finding that the patient is a high risk colon adenocarcinoma patient.

### Example 8

### Predicting the Prognosis of a Patient Diagnosed with Colon Adenocarcinoma

This example provides an exemplary protocol for detecting a more aggressive form of a colon adenocarcinoma in a patient, thereby determining the prognosis of the patient. Determining the prognosis of the patient can be used to select an appropriate therapy, such as adjunctive therapy. As shown in the Examples above, the described inflammatory gene expression signature of colon adenocarcinoma and adjacent non-cancerous tissue identifies patients as either high risk or low risk, thus determining prognosis of the patient.

Expression of PRG1, IL-10, IL-12a, IL-17a, IL-23a, CD68, ANXA1, FOXP3 and HLA-DRA is determined in a colon adenocarcinoma sample and an adjacent non-cancerous colon tissue sample from a subject with stage II colon adenocarcinoma. In addition, expression of miR-21 is detected in the colon adenocarcinoma sample. The samples are obtained during tumor biopsy or surgical resection of the tumor. RNA is isolated from the samples using a commercial kit or other method well known in the art, and subjected to quantitative real time RT-PCR to quantitate expression of the nine inflammatory genes and miR-21.

The inflammatory risk score is calculated by obtaining the resulting raw values for expression of the nine inflammatory genes in the colon adenocarcinoma sample and adjacent non-cancerous sample. A risk score is calculated in the non-cancerous tissue according to the following model: [(0.855*PRG1)+(0.720*IL-10)+(0.458*CD68)+(−0.494*IL-23a)+(−0.635*IL-12a)]. The risk score in the colon adenocarcinoma sample is calculated according to: [(1.321*PRG1)+(0.840*ANXA1)+(0.123*IL-23a)+(0.484*IL-17a)+(0.367*FOXP3)+(−0.373*HLA-DRA)]. Risk scores for non-cancerous tissues and adenocarcinoma tissues are calculated by summing the products of gene expression values and the relevant coefficients from the equations. To assess the level of risk for a patient, risk scores are also calculated for a control (referent) sample (for example, healthy colon tissue), using the non-cancerous and cancerous risk equations above. Referent samples are used to account for any variability in the assay. Risk levels are then be derived by comparing a patient's cancerous and non-cancerous risk scores to the referent sample. If a patient has higher risk scores for the adenocarcinoma and non-cancerous tissue compared to the control sample, they are classified as high risk.

To further validate the patient's risk status, expression of miR-21 in the colon adenocarcinoma tissue sample is evaluated. Expression of miR-21 that is at least 3-fold greater in the tumor sample relative to a reference value (an average of miR-21 expression in non-cancerous tissue) predicts a poor prognosis for the patient. A combination of a high IRS and increased expression of miR-21 in the tumor tissue is a strong indicator of a poor prognosis for the patient.

### Example 9

### Treating a High Risk Colon Adenocarcinoma Patient

This example describes the treatment of a colon adenocarcinoma patient that has been identified as high risk. The high risk patient with poor prognosis is a candidate for adjunctive therapy. Following surgical resection of the tumor, the patient is administered chemotherapy as the adjunctive therapy. An appropriate chemotherapy agent and treatment regimen can be determined by one of skill in the art. Chemotherapy protocols for treating patients with colon adenocarcinoma are well known in the art (see, for example, Lembersky et al., J. Clin. Oncol. 24:2059, 2006; and Haller et al., J. Clin. Oncol. 23:8671, 2005, herein incorporated by reference).

A high risk colon adenocarcinoma patient is administered 5-fluorouracil (5-FU) in combination with leucovorin. 5-FU (500 mg/m²) is administered by intravenous bolus injection one hour after the start of leucovorin administration. Leucovorin (500 mg/m²) is administered intravenously over the course of two hours. This treatment is administered weekly for six weeks, followed by a two week break in treatment. The 8-week treatment cycle is repeated for a total of 3 or 4 cycles.

This disclosure provides a method of predicting the prognosis of a patient diagnosed with colon adenocarcinoma. It will be apparent that the precise details of the methods described may be varied or modified without departing from the spirit of the described disclosure. We claim all such modifications and variations that fall within the scope and spirit of the claims below.

1. A method for detecting a more aggressive form of a colon adenocarcinoma in a subject, comprising:
quantifying expression of a plurality of inflammatory genes in the colon adenocarcinoma, wherein the plurality of inflammatory genes consists essentially of proteoglycan 1 (PRG1), annexin A1 (ANXA1), interleukin (IL)-17a, IL-23a, forkhead box P3 (FOXP3) and human leukocyte antigen (HLA)-DRA; and
comparing expression of PRG1, ANXA1, IL-17a, IL-23a, FOXP3 and HLA-DRA in the colon adenocarcinoma to a control;
wherein an increase in expression of at least two of PRG1, ANXA1, IL-17a, IL-23a FOXP3 and HLA-DRA in the colon adenocarcinoma compared to the control indicates a more aggressive form of the colon adenocarcinoma.

2. The method of claim 1, wherein quantifying expression of a plurality of inflammatory genes comprises determining a gene expression signature of the colon adenocarcinoma.

3. The method of claim 2, wherein the gene expression signature of the colon adenocarcinoma is compared to a control gene expression signature.

4. The method of claim 1, further comprising calculating an inflammatory risk score.

5. The method of claim 1, wherein an increase in expression of each of PRG1, ANXA1, IL-17a, IL-23a FOXP3 and HLA-DRA in the colon adenocarcinoma compared to the control indicates a more aggressive form of the colon adenocarcinoma.

6-7. (canceled)

8. The method of claim 1, further comprising:
quantifying expression of a plurality of inflammatory genes in adjacent non-cancerous tissue, wherein the plurality of inflammatory genes consists essentially of PRG1, IL-10, CD68, IL-12a and IL-23a; and
comparing expression of PRG1, IL-10, CD68, IL-12a and IL-23a in the adjacent non-cancerous tissue to a control;
wherein an increase in expression of PRG1, IL-10 or CD68, or a decrease in expression of IL-12a or IL-23a, or any combination thereof, in the non-cancerous tissue compared to the control indicates a more aggressive form of the colon adenocarcinoma.

9. The method of claim 8, wherein quantifying expression of a plurality of inflammatory genes comprises determining a gene expression signature of the adjacent non-cancerous tissue.

10. The method of claim 9, wherein the gene expression signature of the non-cancerous tissue is compared to a control gene expression signature.

11. The method of claim 8, further comprising calculating an inflammatory risk score.

12-15. (canceled)

16. The method of claim 8, wherein an increase in expression of PRG1, ANXA1, IL-17a, IL-23a FOXP3 and HLA-DRA in the colon adenocarcinoma relative to the control, an increase in expression of PRG1, IL-10 and CD68 in the adjacent non-cancerous tissue relative to the control, and a decrease in expression of IL-12a and IL-23a in the adjacent non-cancerous tissue relative to the control, indicates a more aggressive form of the colon adenocarcinoma.

17. The method of claim 16, further comprising selecting adjunctive therapy for the subject if a more aggressive form of the colon adenocarcinoma is detected.

18. The method of claim 16, wherein detecting the more aggressive form of the colon adenocarcinoma further comprises establishing a poor prognosis with a decrease in the likelihood of survival.

19. The method of claim 1, wherein the plurality of inflammatory genes further comprises one or more of IL-1a, IL-1b, IL-2, IL-6, IL-8, IL-12b, IL-15, tumor necrosis factor (TNF)-α, interferon (IFN)-γ, colony stimulating factor (CSF)-1, HLA-DPA1 and nitric oxide synthase 2A (NOS2A).

20. The method of claim 1, further comprising quantitating expression of microRNA-21 (miR-21) in the colon adenocarcinoma and comparing expression of miR-21 in the colon adenocarcinoma to a control, wherein an increase in expression of miR-21 in the colon adenocarcinoma relative to the control indicates a more aggressive form of the colon adenocarcinoma.

21-23. (canceled)

24. The method of claim 20, wherein expression of miR-21 is increased at least 2-fold, at least 3-fold, or at least 4-fold in the colon adenocarcinoma relative to the control.

25. The method of claim 20, wherein the control is non-cancerous tissue obtained from the subject, colon tissue obtained from a healthy subject or a standard value.

26-28. (canceled)

29. The method of claim 1, wherein the colon adenocarcinoma is a stage II colon adenocarcinoma.

30-33. (canceled)

34. A method for selecting a subject diagnosed with colon adenocarcinoma as a candidate for adjunctive therapy, comprising:
quantifying expression of a plurality of inflammatory genes in the colon adenocarcinoma and in adjacent non-cancerous tissue, wherein the plurality of inflammatory genes consists essentially of PRG1, IL-10, IL-12a, IL-17a, IL-23a, CD68, ANXA1, FOXP3 and HLA-DRA; and
comparing expression of PRG1, ANXA1, IL-17a, IL-23a FOXP3 and HLA-DRA in the colon adenocarcinoma and expression of PRG1, IL-10, CD68, IL-12a and IL-23a in the adjacent non-cancerous tissue to a control;
wherein an increase in expression of PRG1, ANXA1, IL-17a, IL-23a FOXP3 and HLA-DRA in the colon adenocarcinoma relative to the control, an increase in expression of PRG1, IL-10 and CD68 in the adjacent non-cancerous tissue relative to the control, and a decrease in expression of IL-12a and IL-23a in the adjacent non-cancerous tissue relative to the control indicates the subject is a candidate for adjunctive therapy.

35. The method of claim 34, wherein the colon adenocarcinoma is a stage II colon adenocarcinoma.

36. The method of claim 34, further comprising quantitating expression of miR-21 in the colon adenocarcinoma and comparing expression of miR-21 in the colon adenocarcinoma to a control, wherein an increase in expression of miR-21 in the colon adenocarcinoma relative to the control indicates the subject is a candidate for adjunctive therapy.

37. The method of claim 36, wherein expression of miR-21 is increased at least 2-fold, at least 3-fold, or at least 4-fold in the colon adenocarcinoma relative to the control.

38. An array consisting essentially of probes specific for PRG1, ANXA1, IL-17a, IL-23a, FOXP3, miR-21 and HLA-DRA.

39. The array of claim 38, further comprising probes specific for IL-10, CD68 and IL-12a.

40. (canceled)

41. The array of claim 38, consisting of probes specific for PRG1, ANXA1, IL-17a, IL-23a, FOXP3, HLA-DRA, IL-10, CD68, IL-12a, miR-21 and 0 to 5 housekeeping genes.
